(19) United States
(12) Patent Application Publication
(10) Pub. No.: US 2012/0031249 A1
(43) Pub. Date: Feb. 9, 2012

(54) Method for refining texture of ferrous material, and ferrous material and blade having microscopic texture

(75) Inventors: Yoshiaki Morisada, Osaka-shi (JP); Toru Nagaoka, Osaka-shi (JP); Masao Fukuzumi, Osaka-shi (JP); Hidetoshi Fujii, Suita-shi (JP); Tadashi Mizuno, Osaka-shi (JP)

(73) Assignees: Osaka Municipal Technical Research Institute, Osaka-shi (JP); KABUSHIKIKAISHA AMC, Osaka-shi (JP); OSAKA UNIVERSITY, Suita-shi (JP)

(21) Appl. No.: 12/806,160

(22) Filed: Aug. 6, 2010

(51) Int. Cl. B26D 1/00; B21K 11/00; C22C 38/00; C23C 8/26; C23C 8/02

(52) U.S. Cl. 83/651; 148/230; 148/221; 148/318; 420/8; 76/104.1

(57) ABSTRACT

A method for refining the texture of a ferrous material. The method includes a first step and a second step. The first step includes a step of making carbide particles in a portion of a base material smaller. The second step includes a step of nitriding at least a part of said portion.

### TECHNICAL FIELD

The present invention is related to a method for surface reforming by refining the texture of a surface layer part in a ferrous material, also related to a ferrous material having a microscopic texture, especially related to a profitable method for manufacturing tool steels and blades having microscopic texture. Furthermore, the expression “refining a texture” means the refinement of crystal grains of a base metal material and the refinement of carbides existing in the base metal material.

### CROSS-REFERENCE TO RELATED CASES

An international application PCT/JP2008/067565, filed on Sep. 26, 2008 is incorporated herein by reference.

A following published paper is incorporated herein by reference: Yoshiaki Morisada, Hidetoshi Fujii, Tadashi Mizuno, Genryu Abe, Toru Nagaoka, Masao Fukusumi, “Modification of nitride layer on cold-work tool steel by laser melting and friction stir processing”, Surface & Coatings Technology 204 (2009) 386-390

### BACKGROUND OF THE INVENTION

The demands for improved function and prolonged service life of cutting tools, blades, and the like are upraised in various fields of industry and health care. From the point of sharpness, there is not only desire of having high hardness of the material that forms cutting tools and blades, but also requisite to refine the texture of the material for making a sharp cutting edge.

It is well known that the mechanical properties (such as hardness, strength) of metal material are largely influenced by the size of the diameter of the crystal which forms the metal. Generally, the smaller the diameter of crystal grain, the higher the mechanical properties of metal material. Although the methods for refining the crystal grain of the metal such as ECAP (Equal Channel Angular Pressing) or ARB (Accumulative Roll Bonding) etc. had been developed, (Japan Laid-open Patent Publication No. 2003-096551, Japan Laid-open Patent Publication No. 2000-073152), there still are problems that the refinement of ferrous material especially tool steel used for cutting tools and blades is extremely difficult. The technology of obtaining tool steel with microscopic texture by solidifying metallic powder of severe deformation has been published (New Energy and Industrial Technology Development Organization Nanometal technology project', report of “Reach and Development on Super Strengthened and Super Anticorrosive Tool Steel by Nano Texture Control”), however it is not easy to obtain a material having necessary size for making cutting tools and blades by this method.

Furthermore, at the condition that there are demands of high hardness, high strength, and high wear resistance for various tools, blades, or die and mold, the carbide generating elements such as Cr, Mo, W, V etc., are added into the base material of ferrous material which forms tools and the like. The carbides are separated and diversified in the base material. Because large carbides may lead the sharpness of the cutting tools and blades decline with the shortage of the service life, the refining of the carbides is also important in aspect to the improved function, and prolonged service life of the cutting tools and blades.

From the point of view mentioned above, there were inventors who devised a method to refine texture of metal material through using locally melting of material surface by laser beam. (Japan Laid-open Patent Publication No. 2005-146378). According to this technique, it is possible to refine the carbides in the surface layer part of the metal material. However, the refined carbides were separated from grain boundary of crystal grain of base metal material, and remarkably declined the strength of the grain boundary. Thus the desire of significantly improved properties and prolonged service life of cutting tools, and blades can not be achieved.

### SUMMARY OF THE INVENTION

An aspect of the present invention is a method of modifying a ferrous material. The method includes a first step and a second step. The first step includes making carbide particles in a portion of a base material smaller. The second step includes nitriding at least a part of said portion.

Another aspect of the present invention is a ferrous material. The ferrous material contains a base material and an area. In this area, an average size of carbide particles is smaller than that in the base material. This area contains a nitrided portion.

Another aspect of the present invention is a ferrous material, which contains an area where a micro-Vickers hardness with a load of 100 g at a depth of 60 μm from a surface of the ferrous material is more than one half of a micro-Vickers hardness with a load of 100 g at a depth of 20 μm from a surface of the ferrous material. It is preferable that the micro-Vickers hardness with a load of 100 g at a depth of 20 μm from a surface of the ferrous material is more than 1000 Hv in said area.

### BRIEF DESCRIPTION OF THE DRAWINGS

FIG. 1 is a conceptual diagram depicting the method for refining the texture of a ferrous material of the present invention.

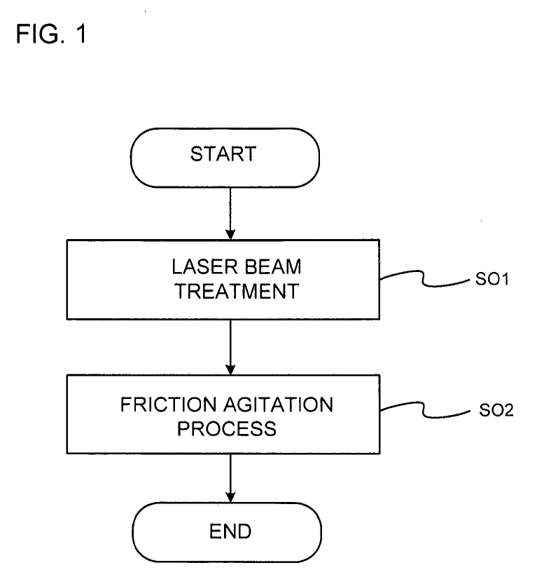

FIG. 2 is a conceptual diagram depicting the first step of the method for refining the texture of a ferrous material of the present invention.

FIG. 3 is a schematic diagram depicting the cross section of the ferrous material after carrying out the first step of the method for refining the texture of a ferrous material of the present invention.

FIG. 4 is a schematic diagram depicting the cross section of the ferrous material after carrying out multiple times the first step of the method for refining the texture of a ferrous material of the present invention.

FIG. 5 is a conceptual diagram depicting the second step of the method for refining the texture of a ferrous material of the present invention.

FIG. 6 is a schematic diagram depicting the cross section of the ferrous material after carrying out the second step of the method for refining the texture of a ferrous material of the present invention.

FIG. 7 is a schematic diagram depicting the cross section of the tool steel having microscopic texture of the present invention.

FIG. 8 is a schematic diagram depicting the cross section of the blade of the present invention.

FIG. 9 is an entire photo depicting a sample obtained from the first embodiment.

FIG. 10 is a photo of optical microscope of untreated DC53 plate material.

FIG. 11 is a photo of optical microscope depicting a melted, rapidly solidified region by the radiation of laser beam.

FIG. 12 is an enlarged photo of FIG. 11.

FIG. 13 is an entire photo depicting a sample obtained from the second embodiment.

FIG. 14 is a photo of optical microscope depicting the cross section of a sample obtained from the second embodiment.

FIG. 15 is a result of Vickers hardness test of a sample obtained from the second embodiment.

FIG. 16 is a photo of scanning electron microscope of the texture refined region.

FIG. 17 is a result of energy dispersive X-ray spectroscopy qualitative analysis of untreated DC53 plate material.

FIG. 18 is a result of energy dispersive X-ray spectroscopy qualitative analysis of the texture refined region.

FIG. 19 is an entire photo depicting a sample obtained from the third embodiment.

FIG. 20 is a photo of optical microscope depicting the cross section of a sample obtained from the third embodiment.

FIG. 21 is a result of Vickers hardness test of a sample obtained from the third embodiment.

FIG. 22 is a photo of a plane having a cutting edge formed by fabricating a texture refined region.

FIG. 23 is a photo of a cutting edge of a plane having a cutting edge formed by fabricating a texture refined region.

FIG. 24 is a photo of a plane having a cutting edge formed by fabricating a texture refined region after cutting test.

FIG. 25 is a photo of a plane having a cutting edge formed by fabricating a carbide refined region after the cutting test.

FIG. 26 is a photo of veneer slicer.

FIG. 27 is a photo of the texture of cutting edge of a veneer slicer.

FIG. 28 is a photo of cutting edge of a veneer slicer after cutting test.

FIG. 29 is a photo of cutting edge of a tailor-made scalpel after cut off test.

FIG. 30 is a photo of cutting edge of a scalpel on the market after cut off test.

FIG. 31 depicts a schematic diagram of a cross section of a ferrous material of an embodiment.

FIG. 32 depicts a schematic diagram of a cross section of a blade of an embodiment.

FIG. 33 illustrates a process chart describing steps of processing a ferrous material.

FIG. 34 illustrates a flow diagram for the preparation of the various nitrided samples.

FIG. 35 shows an optical microscope (OM) image of a cross-section of a steel plate SKD11 treated by the combination of laser melting and friction stir processing (FSP).

FIG. 36 shows microstructural changes of the SKD11 by laser melting and FSP. (a): OM image of the as-received SKD11, (b): OM image of the laser treated SKD11, (c): OM image of the FSPed SKD11, and (d): TEM image of the SKD11 treated by the combination of laser melting and FSP.

FIG. 37 shows OM images of the cross-section of the nitrided SKD11 samples. (a) and (e): as-received SKD11, (b) and (f): laser treated SKD11, (c) and (g): FSPed SKD11, and (d) and (h): SKD11 treated by the combination of laser melting and FSP.

FIG. 38 shows X-ray diffraction (XRD) patterns of the nitrided SKD11 samples.

FIG. 39 shows XRD patterns of the nitrided SKD11 samples without the compound layer.

FIG. 40 shows microhardness depth profiles of the cross-section of the nitrided samples.

### DETAILED DESCRIPTION OF THE INVENTION

### Embodiments of the Invention

### 1. First Embodiment

The method for refining the texture of a ferrous material according to the present invention, comprises a first step in which the surface layer part in the ferrous material is locally and rapidly heated by a laser beam to form a melt reservoir which is then rapidly solidified to form a carbide refined region; and a second step in which the carbide refined region formed in the first step is subjected to a friction agitation process to form a texture refined region. Further, in the first step microplasma welding may be utilized during the surface layer part of the ferrous material is locally and rapidly heated as well as rapidly solidified.

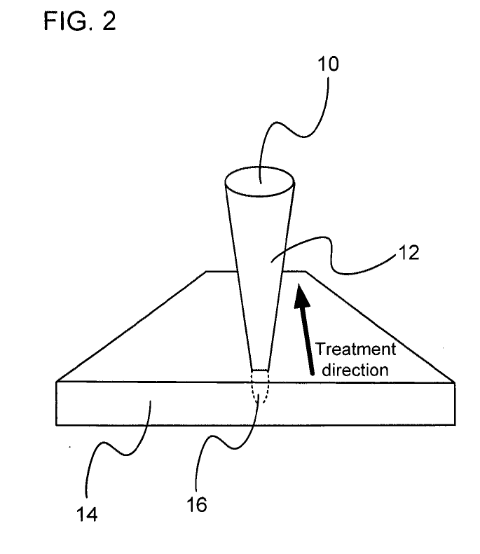

FIG. 2 is depicting an embodiment of the first step of the present invention. A laser beam 12 emitted from laser beam source 10 is condensed at the immediate vicinity of the surface of a ferrous material 14. Because the ferrous material 14 is irradiated by the laser beam 12 in such way, the surface layer part of the ferrous material 14 is heated locally and rapidly, a melt reservoir 16 is formed at the surface layer part. Moreover, the laser beam 12 scans along scanning direction with a prescribed speed. When the laser beam 12 moves from the melt reservoir 16, the melt reservoir 16 is solidified rapidly due to heat diffusion to peripheral region. Therefore, inside of the surface layer part of the ferrous material 14, e.g. the region scanned by laser beam 12, is subjected to rapid heating and rapid solidification. Further, it would be desirable if the laser beam source 10 is a device that can generate laser beam to rapidly heat the surface layer part of the ferrous material 14 and form the melt reservoir 16; and/or it is favorable to use a semiconductor laser.

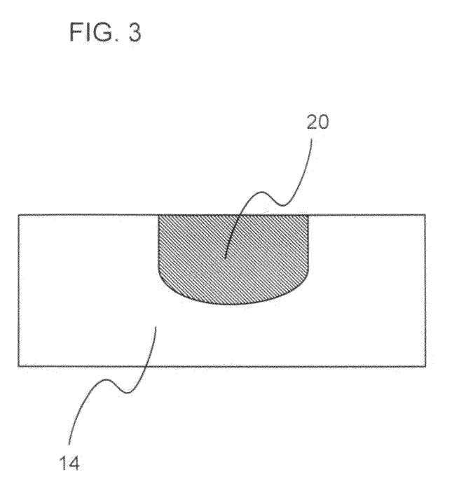

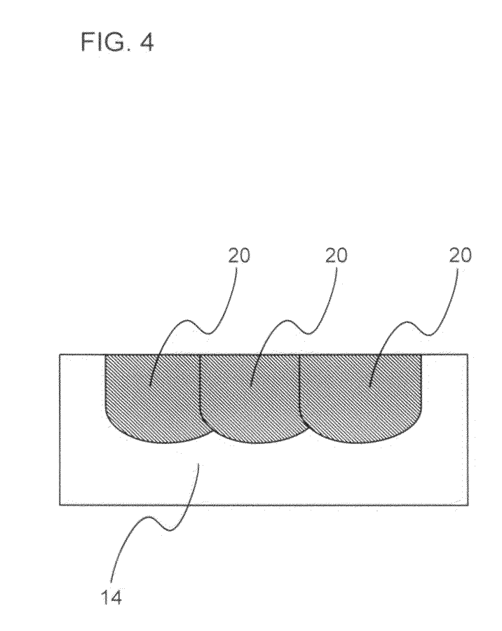

FIG. 3 is a schematic diagram depicting the cross section of the ferrous material after carrying out the first step. The melt reservoir 16 mentioned above is rapidly solidified, a carbide refined region 20 is formed at the surface layer part of the ferrous material 14. If a broader carbide refined region 20 is demanded, it is necessary to operate the laser beam scan multiple times to at least make the carbide refined region 20 formed by one laser scan partially overlap, as depicting in FIG. 4. Then the broader carbide refined region 20 may be obtained.

The second step is a step that the carbide refined region formed in the first step is subjected to a friction agitation process. The said friction agitation process employs a friction agitation joining method which was devised in 1991 at TWI (The Welding Institute) England, as surface reforming method of metal material. The friction agitation joining is a kind of technique comprising press a rotating cylindrical tool at high speed into a joining region (a protruding called as “probe” is located on the bottom of the tool, press the said probe into); agitate a joined material softened by friction to complete the join while scanning along the direction of the joining region. In general the region that is agitated by rotating tool is called as “agitation part”, wherein mechanical properties are improved with homogeneity of material as well as decrease of crystal grain diameter by the joining condition. The technique which employs improvement of mechanical properties with homogeneity of material as well as decrease of crystal grain diameter by means of friction agitation for surface reforming, is friction agitation process, and is largely studied in recent years.

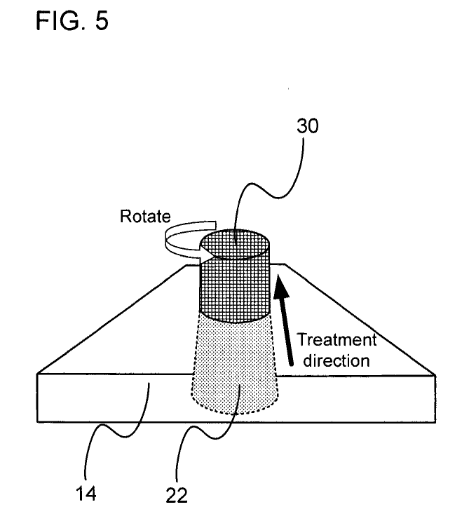

FIG. 5 is depicting an embodiment of step 2. A rotating cylindrical tool 30 is pressed into the carbide refined region 20, then texture refined region 22 is formed due to the scanning along the carbide refined region 20. It is desirable that the rotating speed of the tool 30 is 100-2000 rpm, moving speed is 10-1000 mm/min, compression load is 4903-98066N (500-10000 kgf); but not limited if friction agitation can be achieved. Moreover, if the pressed tool 30 goes out of the carbide refined region 20, rough and large carbides may be dragged into; thus it will be better that tool 30 is pressed into the inner side of the carbide refined region 20. It would be favorable if the shape of tool 30 is just suitable to complete the friction agitation process at the carbide refined region 20; and the existence or shape of the probe on the bottom of tool 30 is not under restriction.

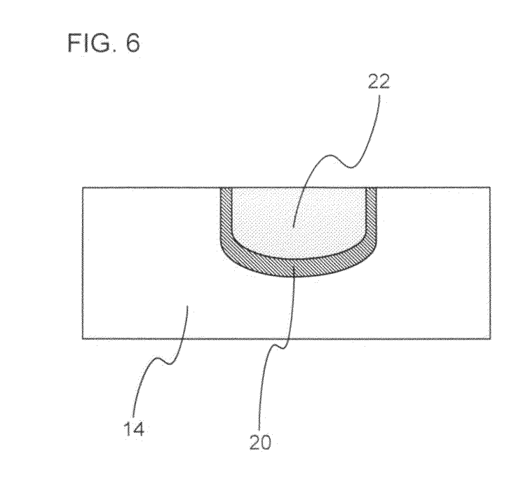

FIG. 6 is a schematic diagram depicting the cross section of the ferrous material after carrying out the second step. By means of performing friction agitation process in the carbide refined region 20, a texture refined region 22 is formed at surface layer part of ferrous material 14. If a broader texture refined region 22 is demanded, it is necessary to operate the laser scan multiple times to at least make the carbide refined region 20 formed by one laser scan overlap partially. After a broader carbide refined region 20 is obtained, it is favorable to perform the second step multiple times on the said carbide refined region 20

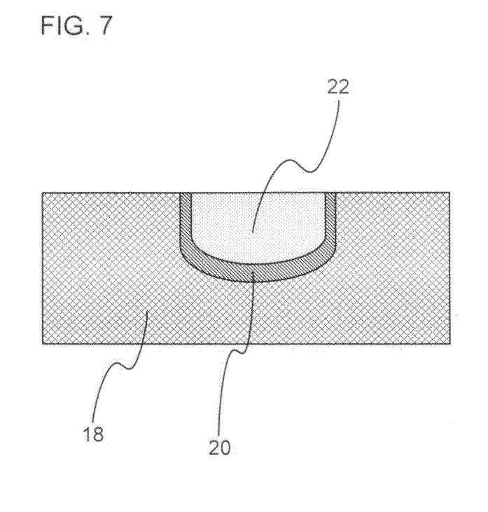

A tool steel having microscopic texture of the present invention as illustrating in FIG. 7 demonstrates a cross section. The diameter of base metal material crystal grains of the tool steel 18 is 5 μm-50 μm; the diameter of base metal material crystal grains in the texture refined region 22 is 10 nm-1 μm. Moreover, the diameter of carbides in the texture refined region 22 is 10 nm-1 μm. Tool steel 18 and the texture refined region 22 exist continuously through the medium of the carbide refined region 20, and no bonding agent or adhesive is between tool steel 18 and the texture refined region 22.

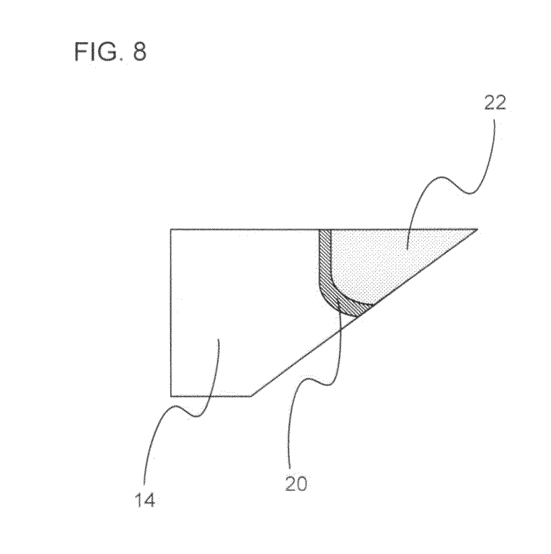

The blade of the present invention as illustrating in FIG. 8 demonstrates a cross section, The cutting edge is fabricated with texture refined region 22. It is desirable that the diameter of base metal material crystal grains of the ferrous material 14 is 5 μm-50 μm, the diameter of base metal material crystal grains in the texture refined region 22 is 10 nm-1 μm. Moreover, it is desirable that the diameter of carbides in the texture refined region 22 is 10 nm-1 μm. Here, some heat treatments such as apposite quenching or tempering etc. may be incorporated during the manufacturing of the blades, and it may occur that the diameter of the base metal material crystal grains of texture refined region 22 and the diameter of the carbides may increase through the heat treatments. The ferrous material 14 and the texture refined region 22 exist continuously through the medium of the carbide refined region 20, and no bonding agent or adhesive is between the ferrous material 14 and the texture refined region 22.

### 2. Second Embodiment

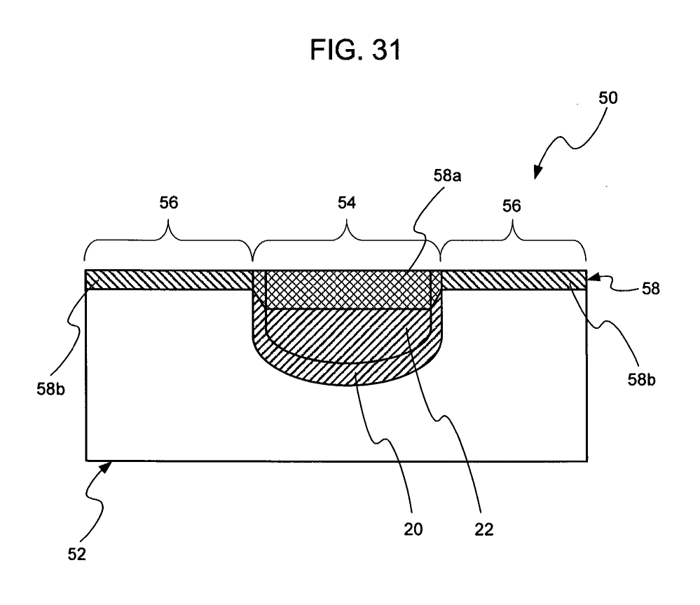

FIG. 31 shows a schematic diagram of a cross section of a ferrous material of the second embodiment. As shown in this drawing, a ferrous material 50 is made of a base material 52. The base material 52 usually contains carbon, which forms carbide particles in the steel. An example of the base material 52 includes a tool steel.

The ferrous material 50 contains two areas, a refined area 54 and a non-refined area 56. The refined area 54 is a part of the base material 52, in which a refining process, such as the laser melting treatment and/or the friction stir processing as described above, was applied. In the case of FIG. 31, the refined area 54 contains two regions, a carbide refined region 20 and a texture refined region 22. The carbide refined region 20 is a portion of the base material 52 that is affected by the laser melting treatment. The texture refined region 22 is a portion of the base material 52 that is affected by the friction stir processing.

In the refined area 54, an average size of the carbide particles is smaller than that in the base material 52. More specifically, an average size of the carbide particles in the refined area 54 is smaller than that in the non-refined area 56. This enhances the strength, hardness and durability of the steel in the refined area 54. Furthermore, this also enhances permeability of nitrogen in the refined area 54 as described later.

In this respect, it is desirable that the average size of the carbide particles in the refined area 54 is less than one fifth of that in the non-refined area 56, which is base material 52 outside of the refined area 54. It is more desirable that the average size of the carbide particles in the refined area 54 is less than one tenth of that in the non-refined area 56. Such characteristic maximizes the above effect. One indicator of the average size of the carbide particles is an average area of the carbide particles observed on the vertical cross section of the ferrous material 50 under optical microscope or transmission electron microscope. Although not limited, a minimal ratio of the average size of the carbide particles in the refined area 54 to that in the non-refined area 56 can be set as one a hundred thousandth.

In the ferrous material 50, a nitrided portion 58 is formed on a surface part of the base material 52. The nitrided portion 58 is a part of the base material 52, in which nitrogen is doped into the base material 52. In this embodiment, the nitrided portion 58 is exposed to a surface of the ferrous material 50. This characteristic provides an ideal property as a blade after the ferrous material 50 is processed into a blade.

As shown in FIG. 31, the nitrided portion 58 covers both the refined area 54 and the non-refined area 56. For convenience, the nitrided portion 58 in the refined area 54 is called a nitrided portion 58a, and the nitrided portion 58 in the non-refined area 56 is called a nitrided portion 58b. It is preferable that a depth of the nitrided portion 58a from the surface of the ferrous material 50 is deeper than a depth of the nitrided portion 58b from the surface of the ferrous material 50. This characteristic makes the ferrous material 50 more suitable as a material for a blade.

In this respect, it is preferable that the depth of the nitrided portion 58a from the surface of the ferrous material is more than 1.2 times deeper than the depth of the nitrided portion 58b from the surface of the ferrous material. It is more preferable that the depth of the nitrided portion 58a from the surface of the ferrous material is more than 1.4 times deeper than the depth of the nitrided portion 58b from the surface of the ferrous material. Such characteristic is ideal for forming a blade from the ferrous material 50. The nitrided portion 58 is often visible on the vertical cross section of the ferrous material 50 under optical microscope because the color or texture of the nitrided portion 58 is often different from that outside of the nitrided portion 58 in the base material 52. In such case, one indicator to measure the depth of the nitrided portion 58 is to regard the portion where the color or the texture changes as a border of the nitrided portion 58. Although not limited, a maximum ratio of the depth of the nitrided portion 58a to that of the nitrided portion 58b can be set as 10.

The nitrided portion 58 contains nitride compounds. Of the nitride compounds, γ′-Fe₄N is most preferred as a component of the nitrided portion 58 particularly in a crystal phase. In other word, it is desirable that the nitride compound contained in the nitrided portion 58 in a largest percentage is γ′-Fe₄N. This compound provides better strength and durability. Major components of the nitrided portion 58 can be determined by X-ray diffraction.

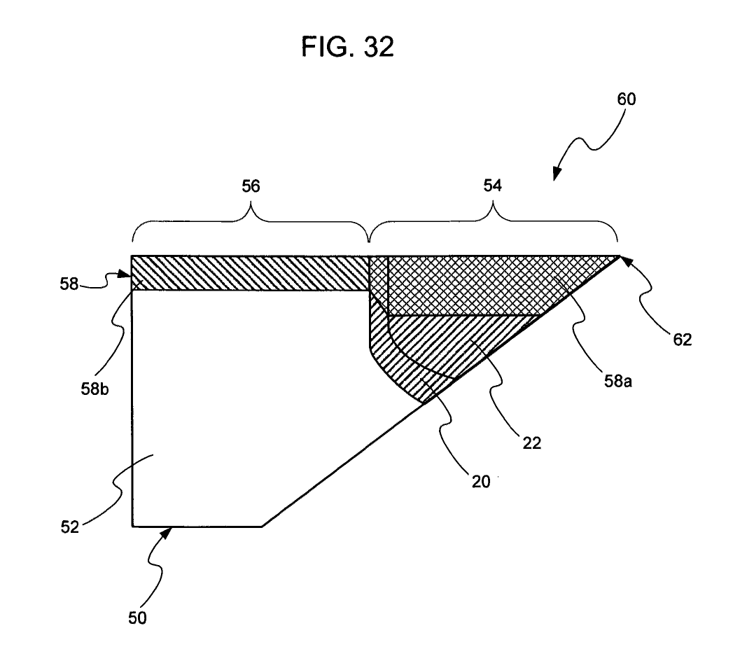

The ferrous material 50 in this embodiment is ideal for forming into a blade because the nitrided portion 58a is very strong, hard and durable. FIG. 32 shows a schematic diagram of a cross section of a blade of this embodiment. As shown in this drawing, the blade 60 is formed by cutting, grinding or sharpening the ferrous material 50 so that one edge of the ferrous material 50 becomes sharp. As shown in FIG. 32, an edge 62 is formed at a sharp end of the blade 60.

The nitrided portion 58a is located at the edge 62. In other word, the edge 62 is made of the nitrided portion 58a. This arrangement adds strength and durability to the edge 62. Thereby, the blade 60 can cut or slice an object more sharply. And, the blade 60 becomes dull less quickly.

### 3. Third Embodiment

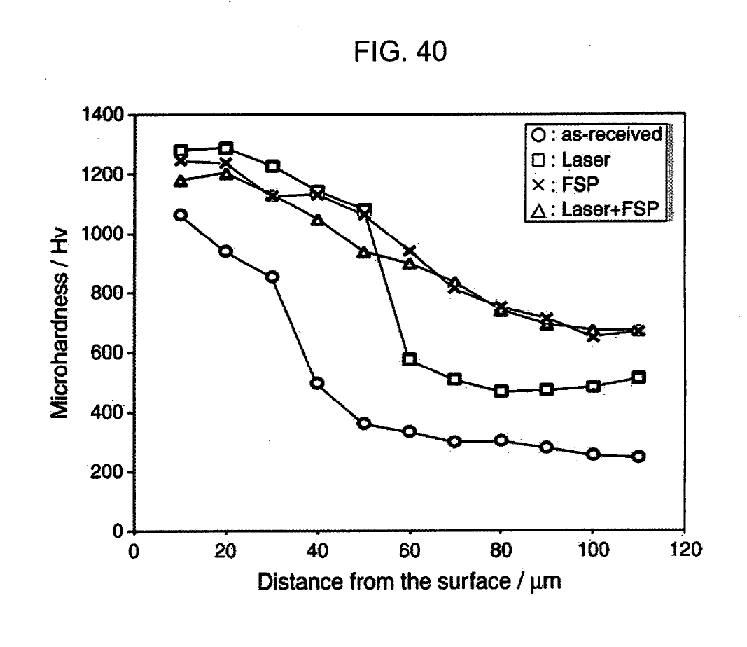

A ferrous material should have an area that has following characteristics. 1) A micro-Vickers hardness close to the surface is large. 2) The micro-Vickers hardness decreases gradually as it goes deeper from the surface. Such ferrous material is optimal as a material for a blade because it adds strength, hardness and durability to the blade. In the previous embodiment, the nitrided portion 58a may have such characteristics. Also, some of the ferrous materials referred in FIG. 40 have such optimal characteristics. Below, characteristics such an area should have will be explained more specifically. In this embodiment, “micro-Vickers hardness” means micro-Vickers hardness with the load of 100 g. Also, a ‘depth’ refers a depth from the surface of the ferrous material.

In the first view point, it is preferable that a micro-Vickers hardness at the depth of 20 is more than 1000 Hv. It is more preferable that a micro-Vickers hardness at the depth of 20 μm is more than 1100 Hv. Such property adds stability and sharpness to the ferrous material when it is formed into a blade.

In the second view point, it is preferable that a micro-Vickers hardness at a depth of 60 μm is more than one half of a micro-Vickers hardness at a depth of 20 μm. It is more preferable that a micro-Vickers hardness at a depth of 60 μm is more than two thirds of a micro-Vickers hardness at a depth of 20 μm. This property is a good indicator that the micro-Vickers hardness doesn't drop suddenly as it goes deeper from the surface. If the ferrous material fulfills such property, strength and durability of the ferrous material become larger.

In this respect, it is preferable that a micro-Vickers hardness at a depth of 60 μm is more than 500 Hv. It is more preferable that a micro-Vickers hardness at a depth of 60 μm is more than 667 Hv. If the ferrous material fulfills such property, it implies that the micro-Vickers hardness close to the surface is large and the micro-Vickers hardness decreases gradually as it goes deeper from the surface.

Furthermore, it is desirable that the ferrous material fulfills following properties. First, it is preferable that a micro-Vickers hardness at a depth of 100 μm is more than one half of a micro-Vickers hardness at a depth of 20 μm. In this respect, it is preferable that the micro-Vickers hardness at the depth of 100 μm is more than 500 Hv. Such ferrous material has a large micro-Vickers hardness in a deep portion of the ferrous material. Such property adds further strength and durability to the ferrous material.

It is desirable that a micro-Vickers hardness decreases gradually from a shallow point (20 μm) through a middle-depth point (60 μm) to a deep point (100 μm). A good indicator of such gradual decrease is that a micro-Vickers hardness at the depth of 60 μm is within ±20% of an average of a micro-Vickers hardness at the depth of 20 μm and a micro-Vickers hardness at the depth of 100 μm. Furthermore, it is preferable that a micro-Vickers hardness at the depth of 60 μm is within ±15% of an average of a micro-Vickers hardness at the depth of 20 μm and a micro-Vickers hardness at the depth of 100 μm. The ferrous material having such property is strong and resistant to breakage against mechanical force even if the ferrous material is shaped to be thin. Thus, such ferrous material is ideal as a material for a blade.

In the same viewpoint, it is preferable that a micro-Vickers hardness at the depth of 60 μm is less than 90% of a micro-Vickers hardness at the depth of 20 μm. It is also preferable that a micro-Vickers hardness at the depth of 100 μm is less than 70% of a micro-Vickers hardness at the depth of 20 μm. Although not limited, maximum values of micro-Vickers hardnesses at depths of 20, 60 and 100 μm can be set as 10000, 9000 and 7000 Hv respectively.

### 4. Fourth Embodiment

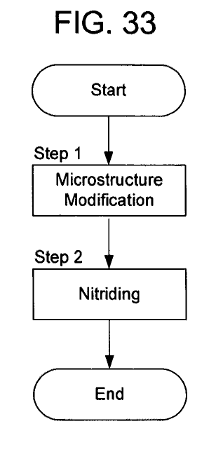

Above ferrous material can be obtained by a following method. FIG. 33 describes steps of processing the ferrous material. As shown in this chart, this process is composed of two main steps.

[Step 1] Modifying microstructures in a portion of the base material 52.

[Step 2] Nitriding at least a part of the portion where the microstructures were modified.

Actually, prior to initiating the first step, it is usual to prepare the base material 52. Thus, the base material 52 is explained first. A steel that contains carbon is optimally used as the base material 52. Furthermore, it is desirable that the steel contains chromium and molybdenum. Although other steels can be used, optimal steels for the base material 52 are tool steels, particularly cold work tool steels.

It is preferable that the base material 52 contains at least 1.2 mass % of carbon. It is more preferable that the base material 52 contains at least 1.4 mass % of carbon. Generally speaking, carbon reacts to nitrogen and forms compounds which reduce the strength of the steel. Contrary to the general knowledge, the inventors discovered that the structural change brought by the Step 1 prevents the steel from being weak even if it contains a large amount of carbon. Rather, it increases the strength of the steel even after the Step 2. Although not limited, a maximum content of carbon can be set as 15 mass %.

It is preferable that the base material 52 contains at least 10 mass % of chromium. It is more preferable that the base material 52 contains at least 11 mass % of chromium. While chromium increases permeability of nitrogen to be doped, it reacts with nitrogen and the formed compounds reduce strength of the steel. The inventors discovered that the structural change brought by the Step 1 prevents the steel from being weak. Therefore, a larger content of chromium does not decrease the strength of the steel but rather increases. Although not limited, a maximum content of chromium can be set as 40 mass %.

It is preferable that the base material 52 contains at most 1.5 mass % of molybdenum. It is more preferable that the base material 52 contains at most 1.0 mass % of molybdenum. While molybdenum increases permeability of nitrogen, it decreases corrosion and rust resistances. The inventors discovered that the structural change brought by the Step 1 facilitates nitrogen permeation in the steel without increasing the content of molybdenum. Although not limited, a minimum content of molybdenum can be set as 0.001 mass %.

### [Step 1] Modifying Microstructures in a Portion of the Base Material 52.

This step makes crystal particles particularly carbide particles in a portion of the base material 52 smaller. In the case of FIG. 31, the refined area 54 is formed by this step. The inventors discovered that if the crystal particles are smaller, nitrogen diffuses better in the base material 52 in the Step 2. Furthermore, the inventors also discovered that when the carbide particles are large, interfaces between the carbide particles and matrix are nitrided unevenly by the Step 2. This causes the brittleness of the ferrous material by nitriding. However, the inventors discovered that when the carbide particles are made small, they are nitrided more evenly and the ferrous material doesn't become brittle. Besides, when carbide particles are large, they are distributed unevenly in the base material 52. The inventors discovered that after the particles are made smaller, they distribute more evenly and thus the ferrous material is nitrided more evenly.

In this respect, it is desirable that by this step an average diameter of the particles is made less than one fifth of that in the base material 52 before this step. It is more desirable that by this step an average diameter of the particles is made less than one tenth of that in the base material 52 before this step. Such small particles maximize the above effect. Furthermore, it is preferable that the average diameter of the particles is made 10 nm-1 μm. One indicator of the average diameter of the particles is an average diameter of the particles observed on the vertical cross section of the ferrous material under an optical microscope or a transmission electron microscope. Although not limited, a minimal ratio of the average diameter of the particles before the Step 1 to after the Step 1 can be set as one ten thousandth.

Ways of making the carbide particles smaller include 1) melting and solidifying a portion of the base material 52, 2) applying a friction on a portion of the base material 52, and 3) welding a portion of the base material 52 by microplasma. The first method, melting and solidifying a portion of the base material, is preferable. As described later, it increases nitriding efficiency. It also increases micro-Vickers hardness combined with nitriding. This method was explained in detail above with FIGS. 2, 3 and 4. The second method, applying a friction on a portion of the base material 52, is more preferable. As described later, this method enables nitrogen to permeate more deeply in the base material 52. In addition, this method provides the base material 52 a property such that micro-Vickers hardness decreases gradually as it goes deeper from the surface of the base material 52. This method was explained in detail above with FIGS. 5 and 6. The Step 1 can be composed of multiple steps. In other word, plural methods described above can be performed on the base material 52. In this case, it is most preferable to melt and solidify a portion of the base material 52 first and to apply a friction on a portion of the base material 52 second. As described later, this combination of the two methods with this order maximizes the efficiency of nitrogen doping. In the case of FIG. 31, the carbide refined region 20 and the texture refined region 22 is formed by combining rapid heating and solidification and a friction agitation process.

[Step 2] Nitriding at Least a Part of the Portion where the Microstructures were Modified.

This step dopes nitrogen in the base material 52. Thereby, the ferrous material 50 becomes stronger, harder and more durable. In the case of FIG. 31, the nitrided portion 58 is formed by this step.

One good way to nitride the base material 52 is to expose the base material 52 in an active gas containing a nitrogen atom. Examples of the gas containing a nitrogen atom include ammonia, ammonia derivatives, hydrazine and hydrazine derivatives. Examples of ammonia derivatives and hydrazine derivatives are compounds in which at least one of the hydrogen atoms of ammonia or hydrazine is replaced by a carbohydrate group. Ammonia is most preferably used for nitriding the base material 52. Ammonia diffuses efficiently in the base material 52. Thus, it can nitride the base material 52 with larger depth. In addition, it can nitride the base material 52 more homogeneously.

An inert gas can be mixed with the gas containing a nitrogen atom. Examples of the inert gas include nitrogen gas and argon gas. Ratio of the inert gas and the gas containing a nitrogen atom can be 1:10 to 10:1.

Nitriding can be preferably performed at 300-800° C. for 3-8 hours. In such condition, micro-Vickers hardness tends to be large at a portion close to the surface of the base material 52 and tends to decrease gradually as it goes deeper from the surface of the base material 52.

It is preferable to initiate the Step 2 within 72 hours after finishing the Step 1. It is more preferable to initiate the Step 2 within 24 hours after finishing the Step 1. This can bring more homogeneous nitriding.

Prior to the Step 2 after the Step 1, the base material 52 can be pretreated to activate its surface. An example of the pretreatment includes exposing the base material 52 in an acid gas such as hydrogen disulfide gas. This increases the efficiency of nitrogen doping.

After the Step 2, the ferrous material 50 can be formed into the blade 60 so that the part of the base material 52, whose microstructure was modified and which was nitrided, is located at the edge 62.

In the above embodiments, the ferrous material was used to form the blade. It is not to mention that the ferrous material of the above embodiments can be used for other purposes such as producing drill bits or other tools. The ferrous material in the above embodiments is suitably used as a material for producing articles, for which strength, hardness or durability is needed.

### EXAMPLES

Examples of the present invention will be described below with reference to the accompanying drawings. The specification and figures are to be regarded in an illustrative rather than a restrictive sense, and all modifications are intended to be included within the scope of present invention. Further, the treated material e.g. DC 53, used in the embodiments is general-purpose cold-work steel which is a kind of tool steel with excellent malleability.

### First Example

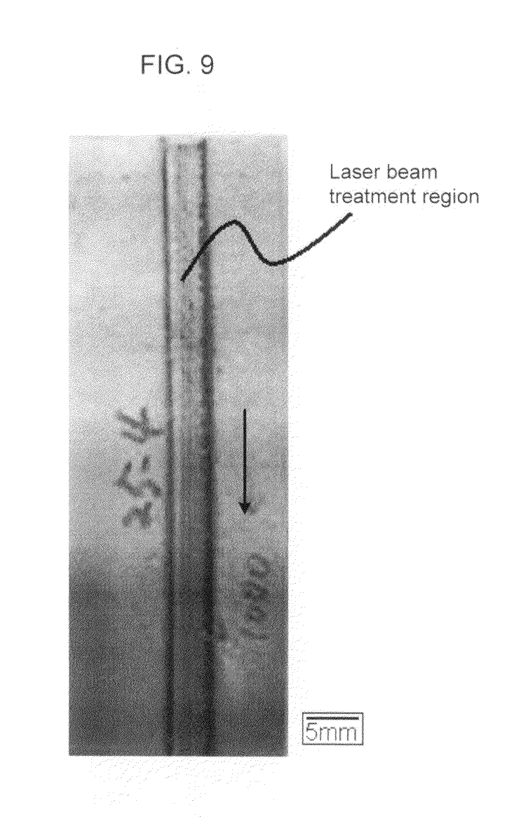

In a DC 53 plate material, there is formed a carbide refined region by using semiconductor laser (output: 1 kW). The laser beam is just focused at the surface of the DC 53 plate material (the diameter of laser beam on the surface of the DC 53 plate material is about 1 mm), and the speed of the laser scan is 1000 mm/min. In order to make the carbide refined region formed by each laser scan at least overlap partially, the radiating position of the laser beam will vertically move a distance of 0.7 mm along the laser scan direction after each laser scan is finished, and performs totally 5 times of laser scan. The photo of the obtained sample is depicting in FIG. 9. It can be confirmed whether the region formed by the radiation of laser beam at the surface of DC 53 plate material exists or not.

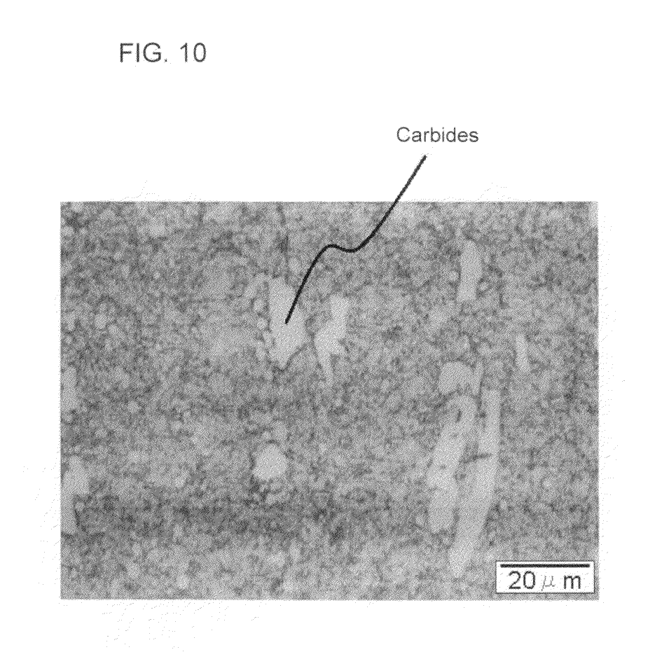

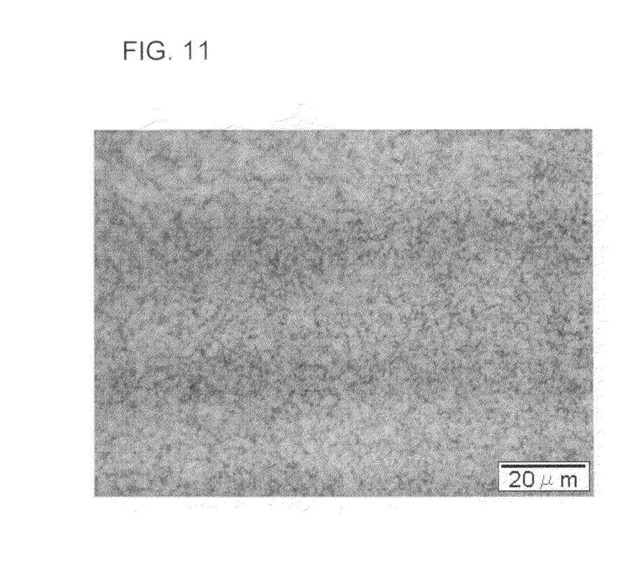

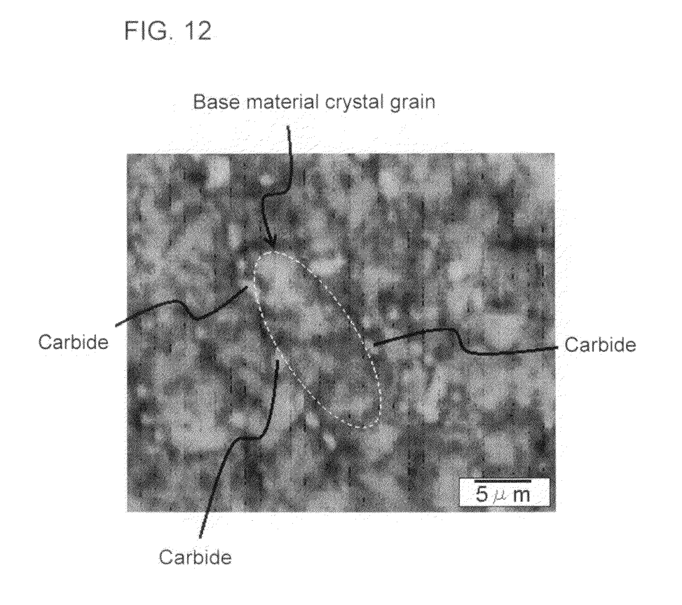

FIG. 10 illustrates an optical microscope photo of untreated DC 53 plate material; and FIG. 11 illustrates an optical microscope photo of melted, and rapidly solidified region by the radiation of laser beam, respectively. Further, at the time of optical microscope observation, each sample is treated with 3% of naithol solution (nitric acid in ethanol) to do etching treatment for sake of observation of the texture easily. It is confirmed that rough and large carbides are over 10 μm in untreated region; but the carbides of the laser beam treated region are refined as small as 1 μm and smaller. FIG. 12 is depicting a result of observing a region of FIG. 11 with higher magnification, and confirms the existence of refined carbides which are arranged at crystal grain boundary of base metal material.

Table 1 indicates Vickers hardness of the region melted and rapidly solidified by the radiation of laser beam from surface towards depth direction. Vickers hardness is measured under the condition that the loading is 2.94N (300 gf) with maintaining time of 15 seconds. The Vickers hardness of the untreated region is at level of 200-300 Hv, but the Vickers hardness of the region subjected to laser beam treatment is enhanced to around 500 Hv

TABLE 1

| | Position from the surface(mm) | | | | | | | | | | |
|---|---|---|---|---|---|---|---|---|---|---|---|
| | 0.05 | 0.1 | 0.2 | 0.3 | 0.4 | 0.5 | 0.6 | 0.7 | 0.8 | 0.9 | 1 |
| Hardness(Hv) | 423 | 474 | 456 | 486 | 553 | 495 | 426 | 458 | 486 | 425 | 289 |

Carbide refined region is from surface to depth of 0.9 mm.

### Second Example

The DC 53 plate material is subjected to laser beam treatment. After the carbide refined region is formed in the DC 53 plate material, the said carbide refined region is subjected to friction agitation process. A semiconductor laser (output: 1 kW) is used to form the carbide refined region, and is just focused on the surface of DC 53 plate material (the diameter of the laser beam on the surface of DC 53 plate material is about 1 mm). Yet the scanning speed of the laser is 1200 mm/min. In order to make the carbide refined region formed by each laser scan at least overlap partially, the radiating position of the laser beam will vertically move a distance of 0.7 mm along the laser scan direction after each laser scan is finished, and performs totally 15 times of laser scan. In the friction agitation process a super hard alloy tool which is cylinder shape with 10 mm of diameter is used. The said tool rotating at a speed of 400 rpm is pressed into the carbide refined region with 2600 kg of loading. The moving speed of the tool is 400 mm/min, and argon gas is flowed in to prevent the tool and the samples from oxidation. Moreover, the insert position of the tool is at the center of the carbide refined region; it should be noted that the untreated DC 53 plate material should not be agitate with the tool.

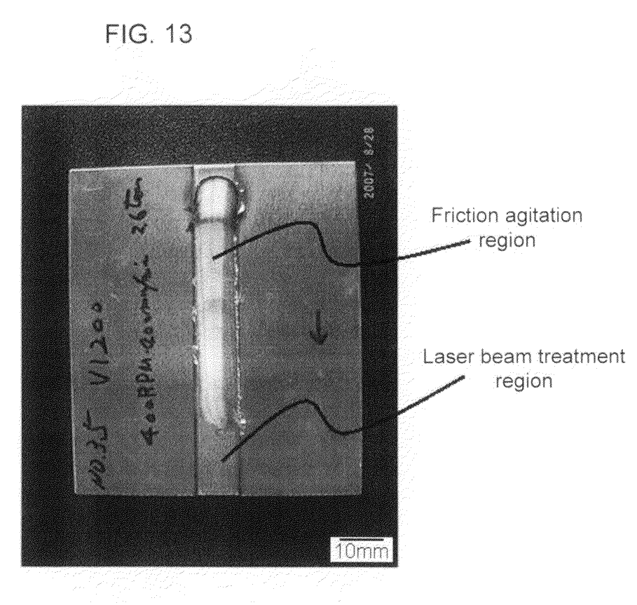

FIG. 13 illustrates a photo of the surface of the obtained sample. The region treated by laser beam is subjected to a friction agitation process. It is confirmed that the friction agitation process has been performed in the region treated by laser beam; and untreated DC 53 plate material is not subjected to friction agitation.

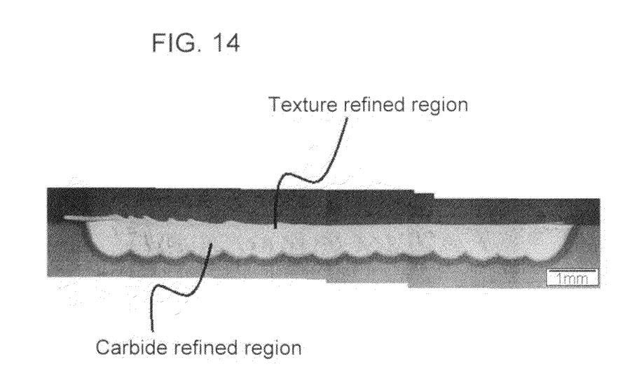

FIG. 14 is an optical microscope photo illustrating the cross section of the obtained sample. Still, at the time of optical microscope observation, the sample is treated with 3% of naithol solution (nitric acid in ethanol) to do etching treatment for sake of observation of the texture easily. There exists a carbide refined region formed by laser beam treatment from the surface of DC 53 plate material to the depth of about 1 mm; also there exists a texture refined region in the said carbide refined region from surface to the depth of about 200 μm. In this embodiment because a cylindrical tool(without probe) is used in the friction agitation process, the press power of the tool is small for the carbide refined region and the influence of friction agitation can not extend to the whole area of the carbide refined region.

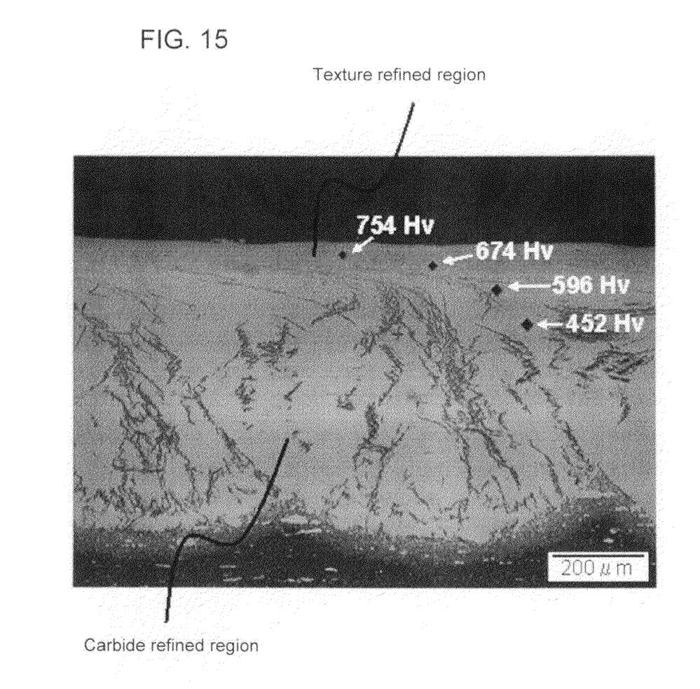

FIG. 15 indicates the result about the measurement of Vickers hardness concerning the obtained sample. Vickers hardness is measured under the condition that the loading is 2.94N (300 gf) over the time of 15 seconds. The Vickers hardness of the texture refined region formed by friction agitation process is largely enhanced compared with the hardness of the carbide refined region formed by only laser beam treatment.

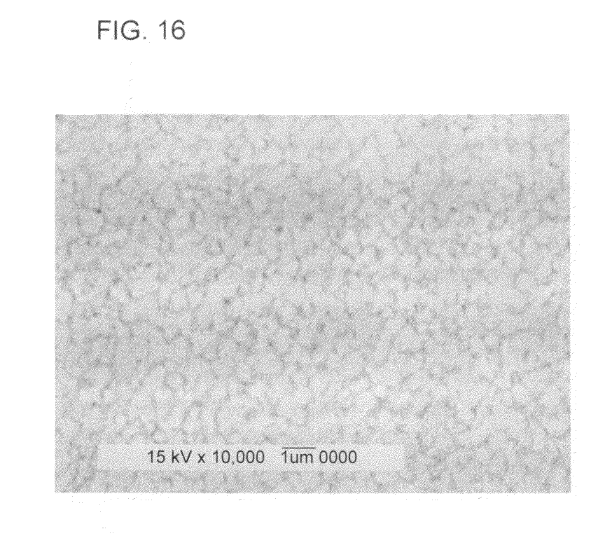

FIG. 16 is a scanning electron microscope photo indicating the texture refined region. Yet, at the time of scanning electron microscope observation, the sample is treated with 3% of naithol solution (nitric acid in ethanol) to do etching treatment for sake of observation of the texture easily. It is regarded that the diameter of the base material crystal grain is obviously lessened to 1 μm, and the diameter of carbides is smaller than that of the base material crystal grain.

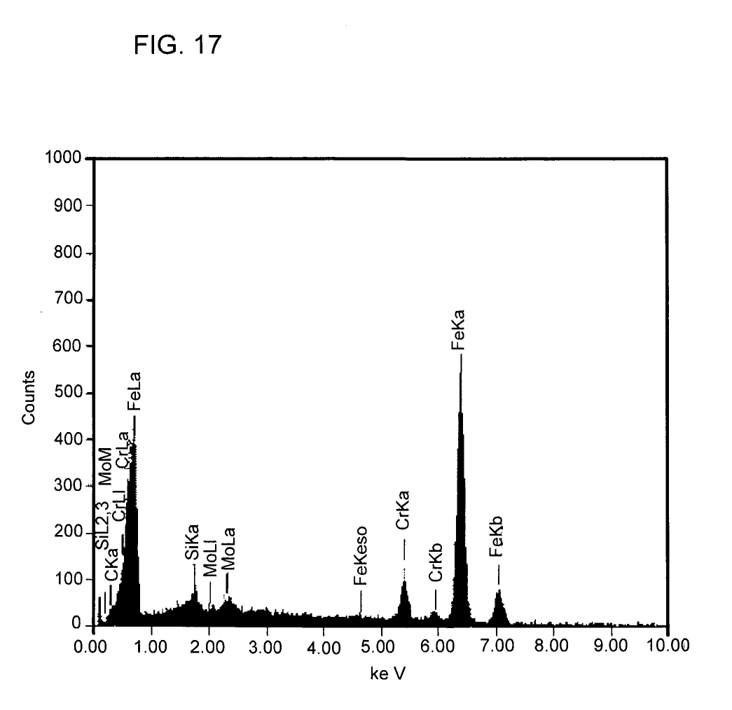

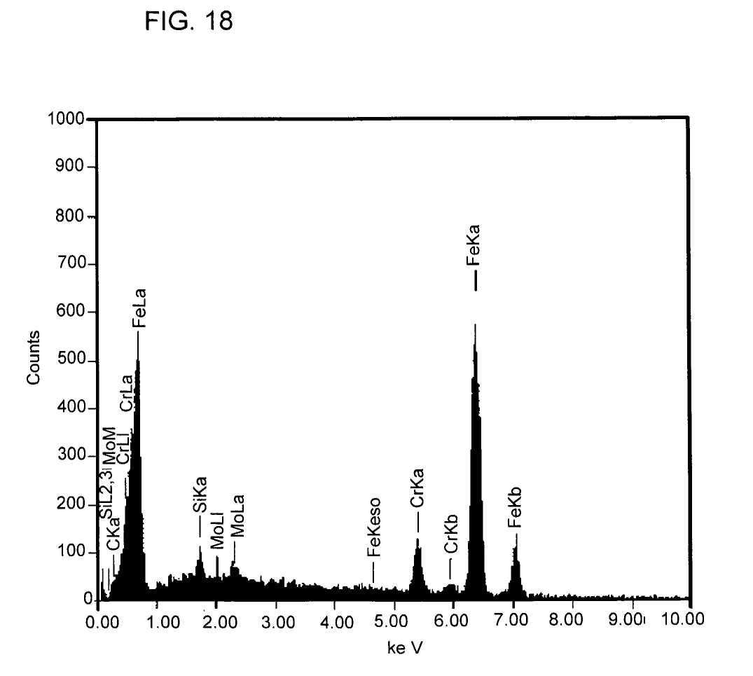

FIG. 17 is a result of energy dispersive X-ray spectroscopy qualitative analysis concerning untreated DC 53 plate material, FIG. 18 is a result of energy dispersive X-ray spectroscopy qualitative analysis concerning the texture refined region formed by laser beam treatment as well as friction agitation process, separately. It is unquestionable that the contexture elements of the untreated DC 53 plate material and the texture refined region are the same, and the method for refining the texture according to the present invention is no addition of other elements.

### Third Example

The DC 53 plate material is subjected to laser beam treatment. After the carbide refined region is formed in the DC 53 plate material, the said carbide refined region is subjected to friction agitation process. A semiconductor laser (output: 1 kW) is used to form the carbide refined region, and is just focused on the surface of DC 53 plate material (the diameter of the laser beam on the surface of DC 53 plate material is about 1 mm). Yet the scanning speed of the laser is 1200 mm/min. In order to make the carbide refined region formed by each laser scan at least overlap partially, the radiating position of the laser beam will vertically move a distance of 0.7 mm along the laser scan direction after each laser scan is finished, and performs totally 15 times of laser scan. In the friction agitation process a super hard alloy tool which is cylinder shape with 10 mm in diameter is used. The said tool rotating at a speed of 400 rpm is pressed into the carbide refined region with 2600 kg of loading. The moving speed of the tool is 400 mm/min, and argon gas is flowed in to prevent the tool and the samples from oxidation. Moreover, the insert position of the tool is adjusted to lead about half of the tool to touch the untreated DC 53 plate material from the carbide refined region; therefore the tool agitates the untreated DC 53 plate material as well as the carbide refined region simultaneously.

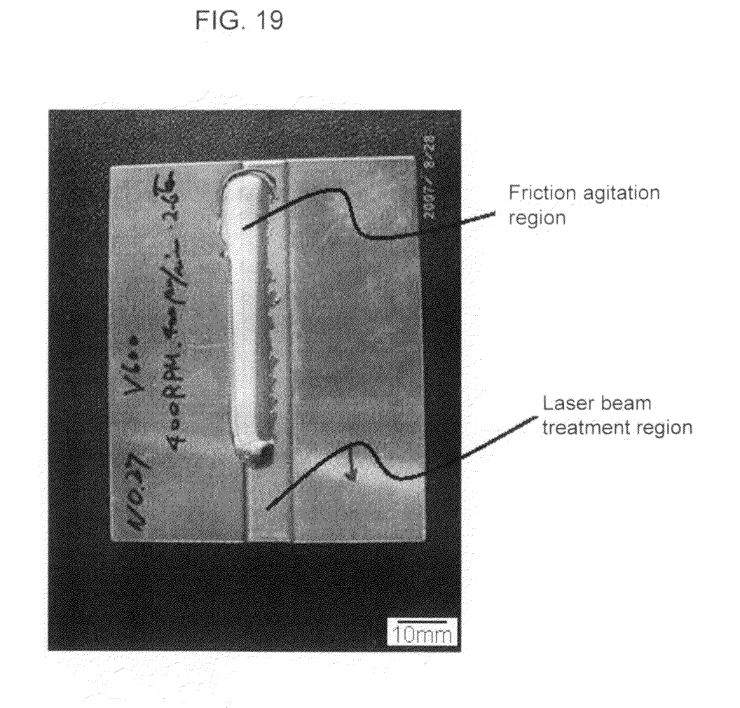

FIG. 19 is a photo indicating the surface of the obtained sample. The friction agitation process is performed on laser beam treated region as well as untreated region simultaneously. It is confirmed that the near center of the tool used in friction agitation process has passed through the boundary vicinity of the laser beam treated region as well as untreated region.

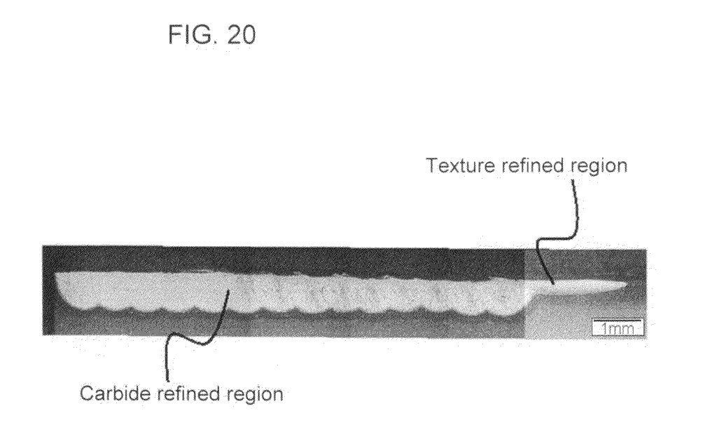

FIG. 20 is an optical microscope photo illustrating the cross section of the obtained sample. Still, at the time of optical microscope observation, the sample is treated with 3% of naithol solution (nitric acid in ethanol) to do etching treatment for sake of observation of the texture easily. There exists a carbide refined region formed by laser beam treatment from the surface of DC 53 plate material to the depth of about 1 mm; also there exists a texture refined region in the said carbide refined region from surface to the depth of about 200 μm.

Further, because the friction agitation process is performed on laser beam treated region as well as untreated region simultaneously, a texture refined region may also exist beyond the carbide refined region. In addition, rougher and larger carbides may exist in surface vicinity of the texture refined region. It is regarded that rough and large carbides which exist in untreated DC 53 plate material by plastic flow due to the friction agitation process may mix into the texture refined region. In this embodiment because a cylindrical tool (without probe) is used in the friction agitation process, the press power of the tool is small for the carbide refined region and the influence of friction agitation can not extend to the whole area of the carbide refined region.

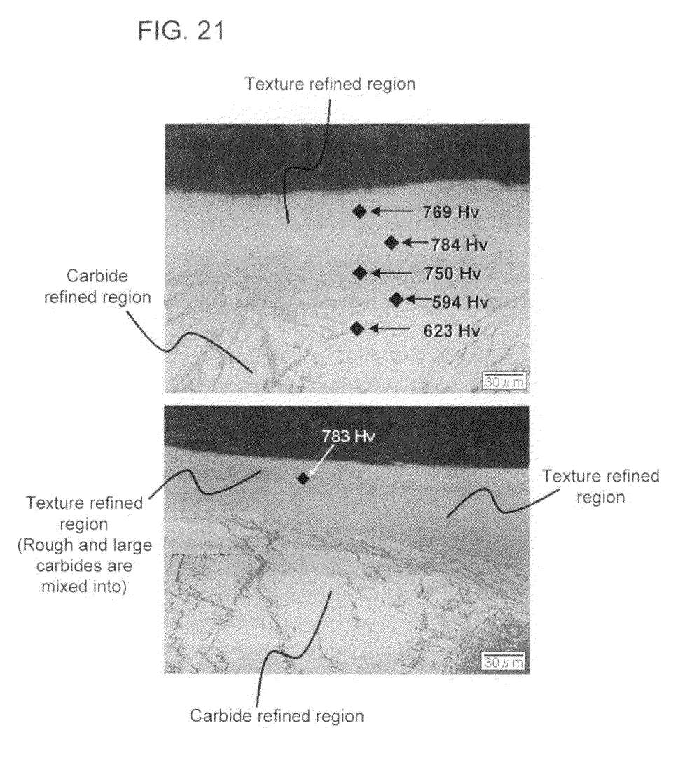

FIG. 21 indicates the result about the measurement of Vickers hardness concerning the obtained sample. Vickers hardness is measured under the condition that the loading is 2.94N (300 gf) with maintaining time of 15 seconds. The Vickers hardness of the texture refined region formed by friction agitation process is largely enhanced compared with the hardness of the carbide refined region formed by only laser beam treatment.

### Fourth Example

The DC 53 plate material is subjected to laser beam treatment. After the carbide refined region is formed in the DC 53 plate material, the said carbide refined region is subjected to friction agitation process. A semiconductor laser (output: 1 kW) is used to form the carbide refined region, and is just focused on the surface of DC 53 plate material (the diameter of the laser beam on the surface of DC 53 plate material is about 1 mm). Yet the scanning speed of the laser is 1200 mm/min. In order to make the carbide refined region formed by each laser scan at least overlap partially, the radiating position of the laser beam will vertically move a distance of 0.7 mm along the laser scan direction after each laser scan is finished, and performs totally 15 times of laser scan. In the friction agitation process a super hard alloy tool which is cylinder shape with 10 mm in diameter is used. The said tool rotating at a speed of 400 rpm is pressed into the carbide refined region with 2600 kg of loading. The moving speed of the tool is 400 min/min, and argon gas is flowed to avoid oxidation of the tool and the samples. After that, the region that is subjected to the friction agitation process (the texture refined region) is fabricated as a cutting edge, and then a plane is done. Again, a carbide refined region which is not subjected to the friction agitation process is fabricated as a cutting edge to make a plane for comparison.

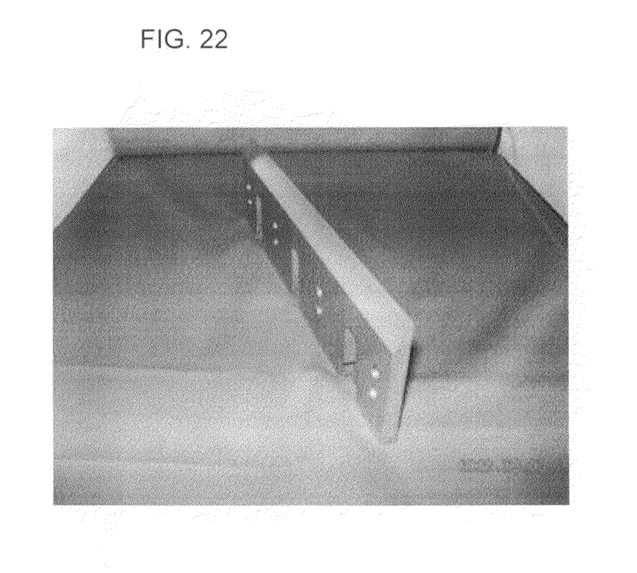

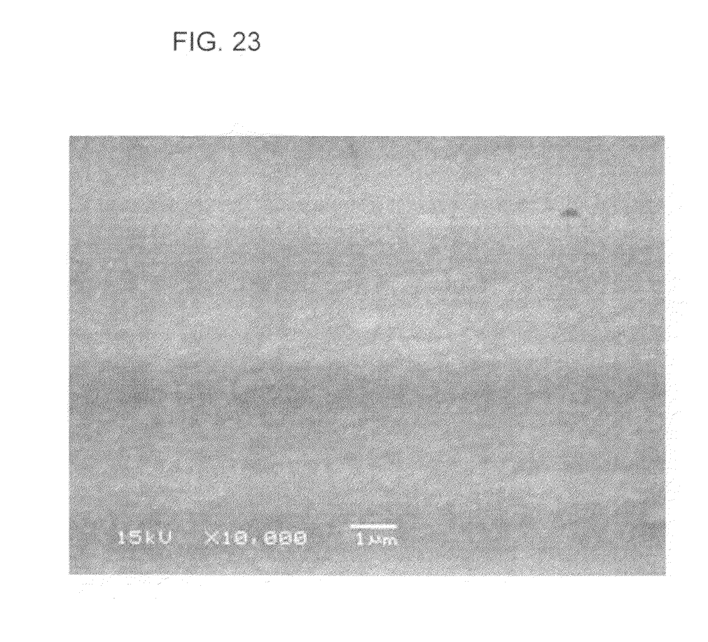

FIG. 22 and FIG. 23 respectively depict a photo concerning the plane wherein a texture refined region is fabricated as a cutting edge and a photo about the texture of cutting edge. It is confirmed that the texture of the cutting edge part is extremely refined, and the diameter of the carbide grain spreading in the said region is smaller than 1 μm.

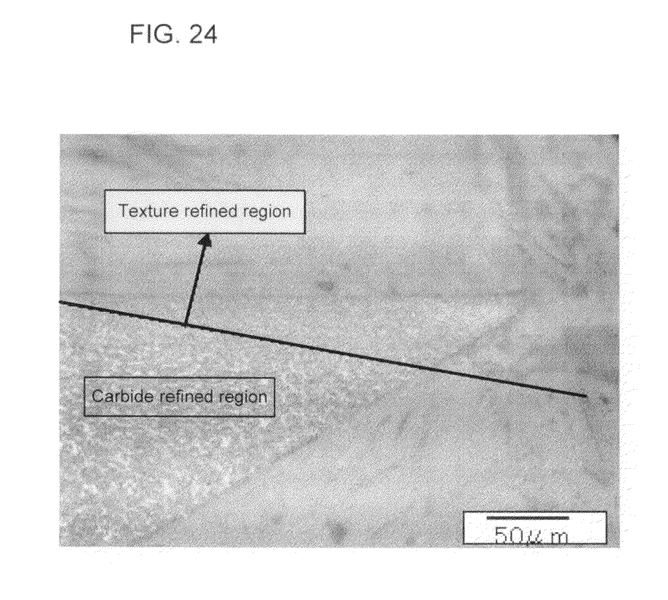

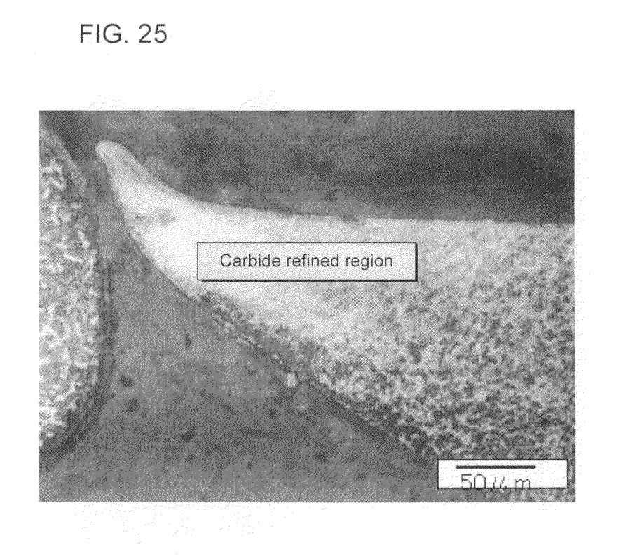

A veneer board called LVL is cut with the fabricated plane to perform valuation of the characteristics of the plane. The cutting condition is as follow: cutting speed is 96 mm/min, cutting depth is 0.15 mm, angle of blade lathe is 35°, and angle of cutting edge of the blade is 31°. After cutting 5 pieces of LVL board in length of 1.8 m, observe the shape of cutting edge by optical microscope. FIG. 24 and FIG. 25 respectively depict the photo concerning the plane wherein a texture refined region is fabricated as a cutting edge and a photo concerning the plane. The cutting edge of the plane wherein carbide refined region is fabricated as a cutting edge is largely out of shape; on the contrary, the cutting edge of the plane wherein a texture refined region is fabricated as a cutting edge is hardly deformed.

### Fifth Example

The DC 53 plate material is subjected to laser beam treatment. After the carbide refined region is formed in the DC 53 plate material, the said carbide refined region is subjected to friction agitation process. A semiconductor laser (output: 1 kW) is used to form the carbide refined region, and is just focused on the surface of DC 53 plate material (the diameter of the laser beam on the surface of DC 53 plate material is about 1 mm). Yet the scanning speed of the laser is 1200 mm/min. In order to make the carbide refined region formed by each laser scan at least overlap partially, the radiating position of the laser beam will vertically move a distance of 0.7 mm along the laser scan direction after each laser scan is finished, and performs totally 15 times of laser scan. In the friction agitation process a super hard alloy tool which is cylinder shape, 10 mm in diameter, is used. The said tool rotating at a speed of 400 rpm is pressed into the carbide refined region with 2600 kg of loading. The moving speed of the tool is 400 mm/min, and argon gas is flowed in to prevent the tool and the samples from oxidation. Afterward, the region subjected to the friction agitation process (the texture refined region) is fabricated as a cutting edge, and a blade (veneer slicer) for carpenter-use is made.

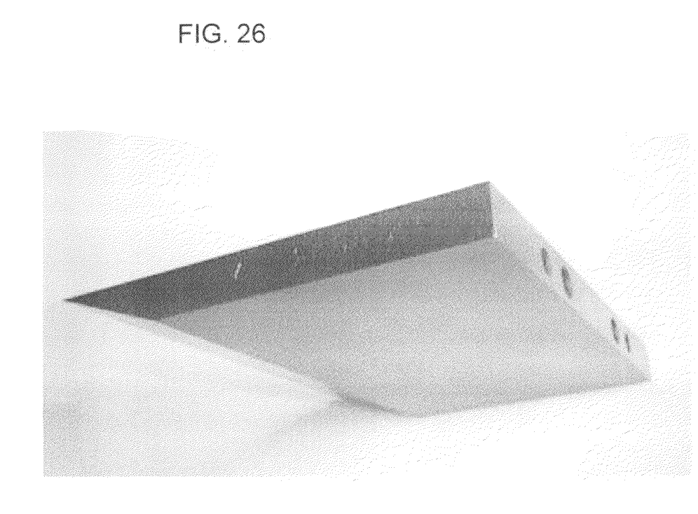

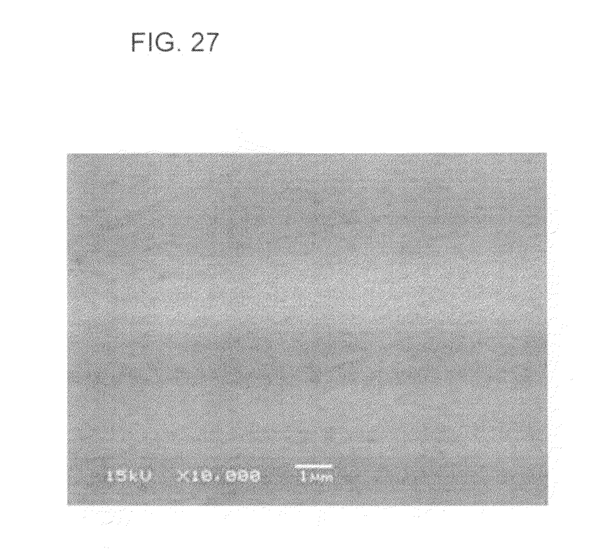

FIG. 26 and FIG. 27 respectively depict a photo concerning a veneer slicer wherein a texture refined region is fabricated as a cutting edge and a photo about the texture of cutting edge. It is confirmed that the texture of the cutting edge part is extremely refined, and the diameter of the carbide grain spreading in the said region is smaller than 1 μm.

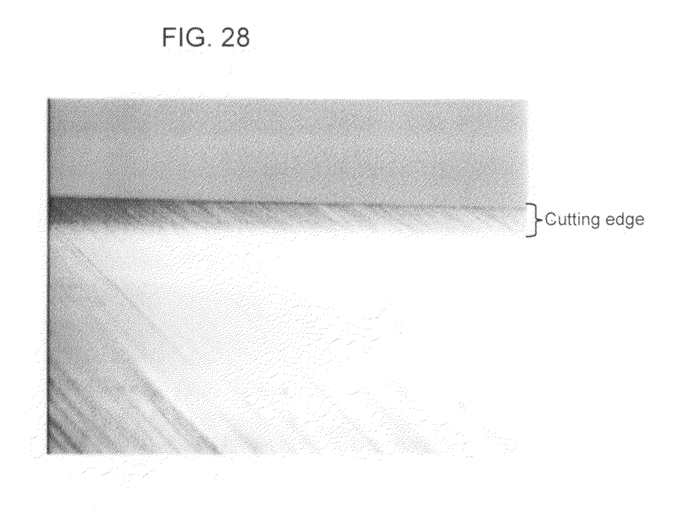

A cedar log is cut with the fabricated veneer slicer to perform the evaluation of the characteristics of the veneer slicer. The cutting condition is as follow: cutting speed is 23 mm/min, cutting depth is 0.3 mm, and angle of cutting edge of the blade is 20°. After cutting about 17 m, observe the shape of cutting edge by optical microscope. FIG. 28 depicts the photo of the cutting edge after cutting test. It is confirmed that there is no marked fragment of the shape of cutting edge at observation, and good shape keeps. Further, there is a limitation at level of 150 μm on cutting to make a thin board of veneer (shaved thin board) with traditional veneer slicer; however, a thin board of veneer of about 75 μm is obtained by using this fabricated veneer slicer.

### Sixth Example

The DC 53 plate material is subjected to laser beam treatment. After the carbide refined region is formed in the DC 53 plate material, the said carbide refined region is subjected to friction agitation process. A semiconductor laser (output: 1 kW) is used to form the carbide refined region, and is just focused on the surface of DC 53 plate material (the diameter of the laser on the surface of DC 53 plate material is about 1 mm). Yet the scanning speed of the laser is 1200 mm/min. In order to make the carbide refined region formed by each laser scan at least overlap partially, the radiating position of the laser beam will vertically move a distance of 0.7 mm along the laser scan direction after each laser scan is finished, and performs totally 15 times of laser scan. In the friction agitation process a super hard alloy tool which is cylinder shape, 10 mm in diameter, is used. The said tool rotating at a speed of 400 rpm is pressed into the carbide refined region with 2600 kg of loading. The moving speed of the tool is 400 mm/min, and argon gas is flowed in to prevent the tool and the samples from oxidation. Afterward, the region subjected to the friction agitation process (the texture refined region) is fabricated as a cutting edge, and then a scalpel is made.

General copy-paper (woodfree paper) is cut off by using the fabricated scalpel as well as scalpel on the market. Evaluation of the characteristics of the scalpels is performed by means of observing the amount of paper cut off and changes of cutting edge shape. A bundle of 950 g copy-paper of 210 pieces is put on the top of a scalpel (the angle between cutting edge and copy-paper is 15°). Calculate the number of pieces of the copy-paper cut off during the said bundle is moved at a speed of 3000 mm/min. Cut off test about one scalpel is performed 20 times continuously; the change of the number of pieces cut off is observed. Yet, Cut off test about one sort of scalpel is performed 6 times of the 20 times continuous cut off test.

Table 2 and Table 3 respectively indicate the number of pieces cut off concerning fabricated scalpel and scalpel on the market. As to the whole cut off test, the number of pieces cut off by the fabricated scalpel is more than the number of pieces cut off by the scalpel on the market. Further, the number of pieces cut off by the scalpel on the market decreases with increase of the number of times of the cut off test; on the contrary, the number of pieces cut off by the fabricated scalpel hardly decreases. From this result, it is demonstrated that the fabricated scalpel is not only sharp but also durable.

TABLE 2

| Number of times of | Test | Test | Test | Test | Test | Test | |
|---|---|---|---|---|---|---|---|
| cutting test | 1 | 2 | 3 | 4 | 5 | 6 | Total |
| 1 | 9 | 10 | 11 | 10 | 9 | 9 | 58 |
| 2 | 9 | 8 | 8 | 9 | 9 | 6 | 49 |
| 3 | 9 | 7 | 7 | 8 | 9 | 8 | 48 |
| 4 | 9 | 7 | 8 | 9 | 8 | 7 | 48 |
| 5 | 9 | 8 | 8 | 7 | 11 | 9 | 52 |
| 6 | 9 | 10 | 9 | 8 | 10 | 8 | 54 |
| 7 | 8 | 10 | 12 | 9 | 10 | 9 | 58 |
| 8 | 8 | 8 | 9 | 8 | 10 | 10 | 53 |
| 9 | 9 | 9 | 10 | 10 | 5 | 6 | 49 |
| 10 | 7 | 8 | 10 | 10 | 10 | 7 | 52 |
| 11 | 7 | 8 | 9 | 10 | 8 | 9 | 51 |
| 12 | 8 | 8 | 10 | 9 | 9 | 12 | 56 |
| 13 | 8 | 9 | 9 | 9 | 11 | 9 | 55 |
| 14 | 8 | 9 | 11 | 10 | 10 | 10 | 58 |
| 15 | 7 | 8 | 8 | 10 | 9 | 10 | 52 |
| 16 | 7 | 11 | 8 | 11 | 10 | 9 | 56 |
| 17 | 7 | 9 | 10 | 10 | 10 | 10 | 56 |
| 18 | 7 | 7 | 8 | 10 | 9 | 9 | 50 |
| 19 | 7 | 8 | 8 | 7 | 9 | 8 | 47 |
| 20 | 6 | 7 | 9 | 8 | 9 | 9 | 48 |
| Total | 158 | 169 | 182 | 182 | 185 | 174 | 1050 |

TABLE 3

| Number of times of | Test | Test | Test | Test | Test | Test | |
|---|---|---|---|---|---|---|---|
| cutting test | 1 | 2 | 3 | 4 | 5 | 6 | Total |
| 1 | 6 | 7 | 6 | 7 | 8 | 6 | 40 |
| 2 | 6 | 7 | 7 | 6 | 6 | 7 | 39 |
| 3 | 6 | 5 | 6 | 6 | 5 | 5 | 33 |
| 4 | 6 | 6 | 6 | 5 | 5 | 5 | 33 |
| 5 | 4 | 5 | 5 | 5 | 4 | 4 | 27 |
| 6 | 4 | 4 | 5 | 5 | 4 | 4 | 26 |
| 7 | 4 | 4 | 4 | 4 | 4 | 3 | 23 |
| 8 | 3 | 5 | 4 | 5 | 4 | 3 | 24 |
| 9 | 4 | 3 | 4 | 4 | 3 | 3 | 21 |
| 10 | 3 | 3 | 3 | 3 | 3 | 3 | 18 |
| 11 | 3 | 3 | 3 | 4 | 3 | 2 | 18 |
| 12 | 2 | 3 | 3 | 3 | 3 | 3 | 17 |
| 13 | 2 | 3 | 2 | 3 | 3 | 2 | 15 |
| 14 | 2 | 2 | 3 | 3 | 2 | 3 | 15 |
| 15 | 2 | 2 | 3 | 3 | 3 | 2 | 15 |
| 16 | 2 | 3 | 3 | 3 | 2 | 2 | 15 |
| 17 | 3 | 3 | 3 | 4 | 3 | 2 | 18 |
| 18 | 2 | 3 | 3 | 3 | 3 | 2 | 16 |
| 19 | 2 | 3 | 3 | 3 | 2 | 2 | 15 |
| 20 | 3 | 3 | 3 | 3 | 3 | 2 | 17 |
| Total | 69 | 77 | 79 | 82 | 73 | 65 | 445 |

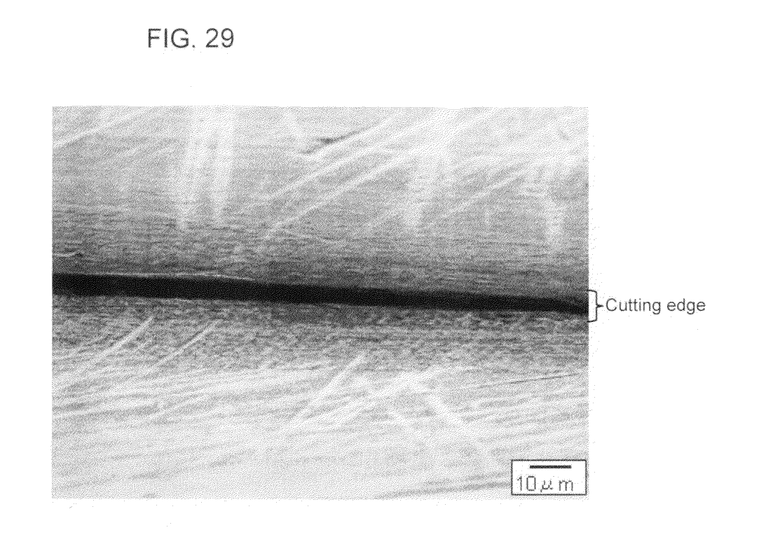

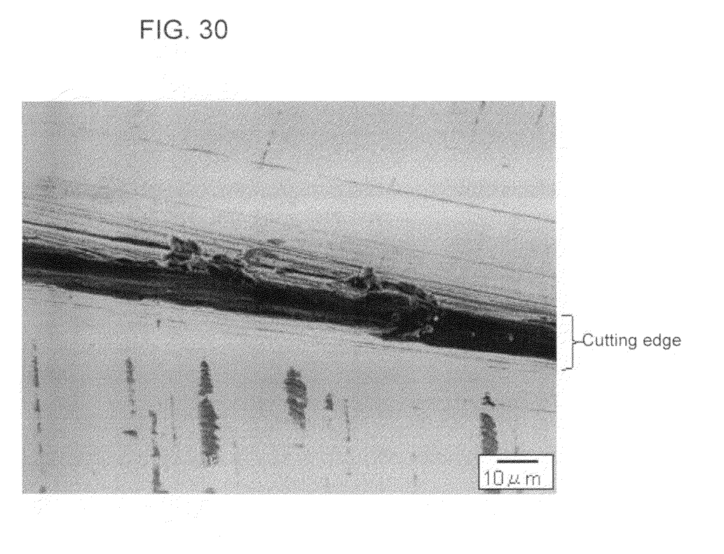

FIG. 29 and FIG. 30 respectively indicate the shape of cutting edge of the fabricated scalpel after cut off test and the shape of cutting edge of the scalpel on the market after cut off test. The cutting edge of the scalpel on the market is largely collapsed in contraposition to that of the fabricated scalpel which the shape of cutting edge hardly changes. It is confirmed that the fabricated scalpel can maintain the sharpness of cutting edge after cut off test compared to the scalpel on the market.

### Seventh Example

### Experimental Procedure

A commercially available plate of SKD11, which is the representative cold-work tool steel, was used. The chemical composition of the SKD11 is shown in Table 4.

TABLE 4

| C | Si | Mn | P | S | Cu | Cr | Mo | V |
|---|---|---|---|---|---|---|---|---|
| 1.48 | 0.29 | 0.35 | 0.25 | 0.01 | 0.09 | 11.74 | 0.85 | 0.22 |

Unit: mass %

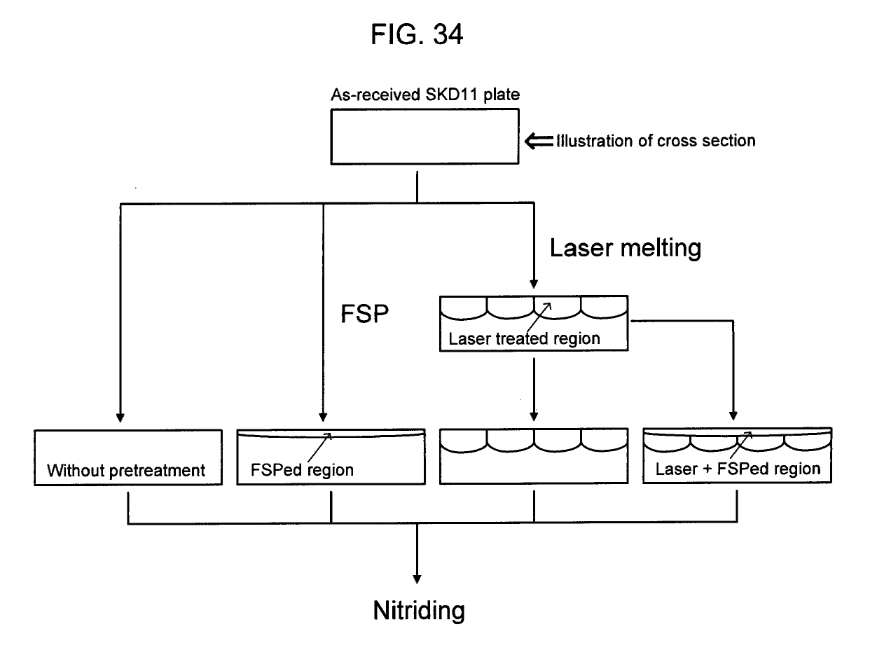

FIG. 34 shows a flow diagram for the preparation of the various nitrided samples. Experiments and results on samples of ‘Without pretreatment’ are comparable to the experiments and results on the non-refined area. Experiments and results on samples of ‘FSPed region’, ‘Laser treated region’ and ‘Laser+FSPed region’ are comparable to the experiments and results on the refined area.

The surface of the SKD11 plate was melted by multi-pass laser heating (1 kW, LASERLINE LDF-1000-750) to produce a rapidly solidified zone. The scanning rate of the laser beam and the beam diameter at the surface of the plate were 1000 mm/min and 1 mm, respectively. The overlap between the beam paths was 0.3 mm. The as-received SKD11 and the laser treated SKD11 were modified by friction stir processing (FSP). The FSP tool made of hard metal (WC—Co) had a columnar shape (Φ12 mm) without a probe. The shape of the tool end was flat. The FSP tool without a probe was effective to form the large treated area on the SKD11 plate which had a high plastic deformation resistance. A constant tool rotating rate of 400 rpm was adopted and the constant travel speed was 400 mm/min. A tool tilt angle of 3° was used. The process was conducted by a single pass. Nitriding was carried out using a mixture of nitrogen (flow rate: 1 L/h) and ammonia (flow rate: 3 L/h) at 540° C. for 5 h. Hydrogen disulfide gas was used to activate the surface of the SKD11 plate for 1 h at the beginning of the nitriding.

Transverse sections of the as-received and the variously treated SKD11 specimens were mounted and then mechanically polished. The microstructures of the samples were observed by optical microscopy and transmission electron microscope (TEM) (JEOL JEM-2100) at an accelerating voltage of 200 kV. The crystal phase of the samples was identified by X-ray diffraction (XRD) (Rigaku RINT2500V). The microhardness was measured using a micro-Vickers hardness tester (Akashi HM-124) with a load of 100 g.

### Results and Discussion

### Microstructural Change in the SKD11 by Pretreatment for Nitriding

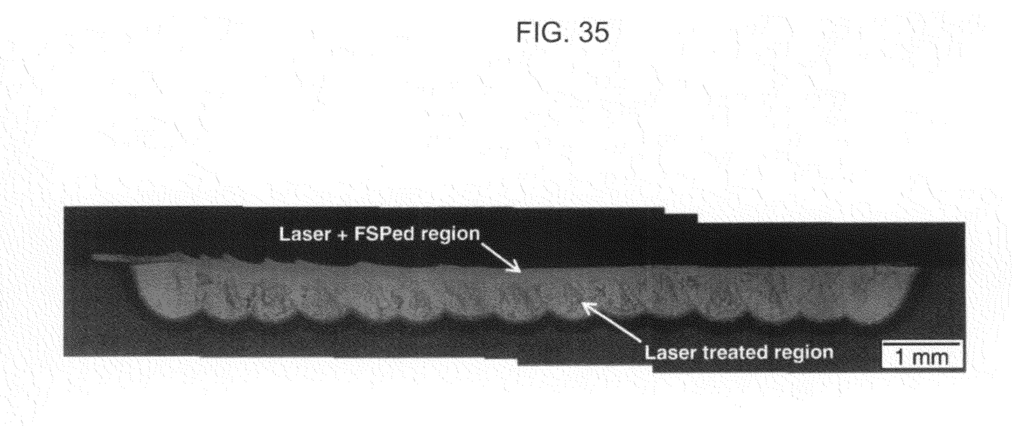

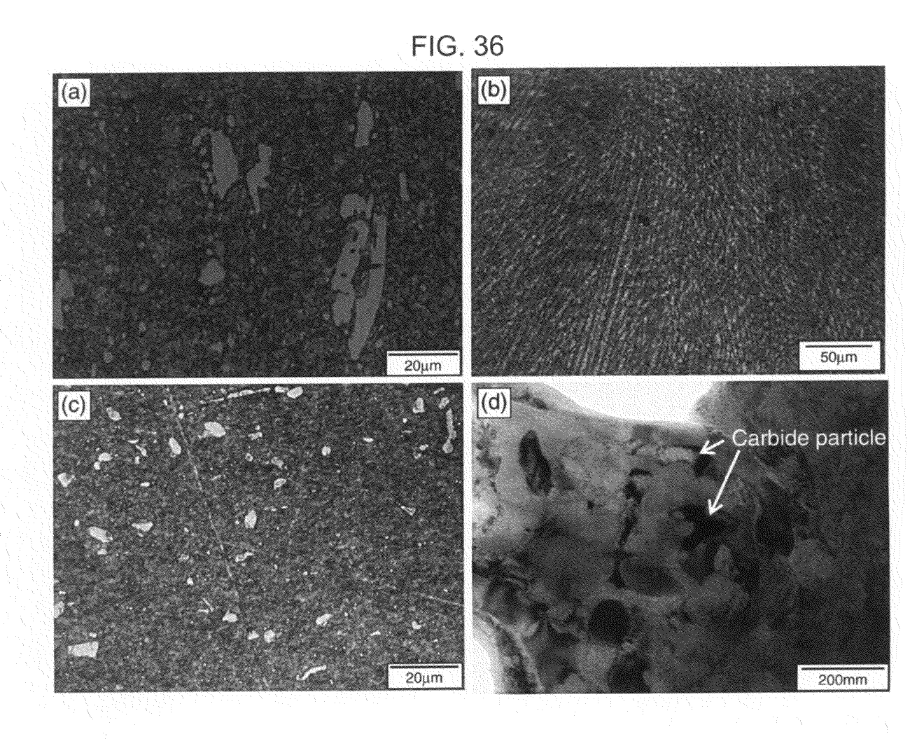

The representative SKD11 plate treated by the combination of laser melting and FSP before nitriding is shown in FIG. 35. The rapidly solidified zone formed by laser melting and the stir zone formed by FSP can be clearly confirmed. No texture was observed in the stir zone using the optical microscope. The thicknesses of the rapidly solidified zone and the stir zone were about 700 μm and 200 μm, respectively. Both thicknesses were sufficient to evaluate the effect of the microstructural change of the SKD11 on the nitrided case. FIG. 36 shows the microstructural change in the SKD11 by laser melting and FSP. There were many coarse chromium carbide particles in the matrix of the as-received SKD11 as shown in FIG. 36 (a). On the other hand, no coarse carbide particles could be confirmed in the rapidly solidified zone as shown in FIG. 36 (b). The laser melting formed a fine dendritic structure consisting of fine carbide particles with sizes of less than 1 μm. Several coarse carbide particles, which were about 10 μm in size could be confirmed in the stir zone without the laser melting as shown in FIG. 36 (c). The size of the refined carbide particles by FSP was also relatively coarser when compared to the SKD11 treated by the combination of laser melting and FSP as shown in FIG. 36 (d). There were no coarse carbide particles and dentritic carbide structure in the FSPed zone with laser melting. The carbide particles and the grains of the matrix became much smaller with sizes of 100 nm and 200 nm, respectively. The microstructural change in the SKD11 by the laser melting, FSP, and the combination of laser melting and FSP were explained in detail elsewhere (Y. Morisada, H. Fujii, T. Nagaoka, M. Fukusumi, Mater. Sci. Eng. A 505 (2009) 157).

### Microstructure and Microhardness of the Diffusion Zone

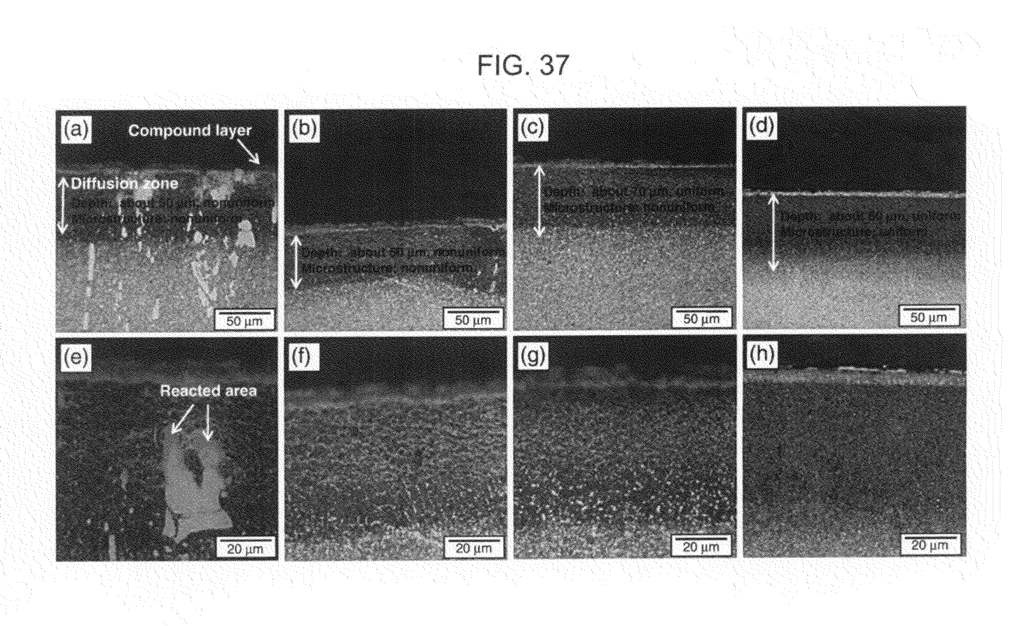

FIG. 37 shows cross-sections of the nitrided SKD11 plates. The diffusion zone of the SKD11 without the pretreatment contained many thick boundary lines consisting of local formed nitride particles. The reacted area could be confirmed on the outer surface of the coarse chromium carbide particles. The uniform diffusion of nitrogen into the SKD11 plate was inhibited by the reaction with the coarse carbide particles. The diffusion zone of the sample treated by the laser melting was also nonuniform. It is considered that the reaction between the small chromium carbide particles on the grain boundary of the matrix and nitrogen led to the local formed nitride particles. On the other hand, the diffusion zone of the samples treated by FSP was relatively uniform compared with the sample treated by laser melting and without any pretreatment. The grain refinement of the matrix by FSP increased the path for the diffusion of nitrogen through the grain boundary. Additionally, the uniform dispersion of the chromium particles prevented the local formation of the nitride particles. There was no conspicuous local formed nitride particle in the diffusion zone for the sample treated by the combination of laser melting and FSP. The uniform nanostructure of the SKD11 realized such a homogeneous diffusion zone due to the many fine grain boundaries and the uniform dispersion of the nanometer sized chromium carbide particles.

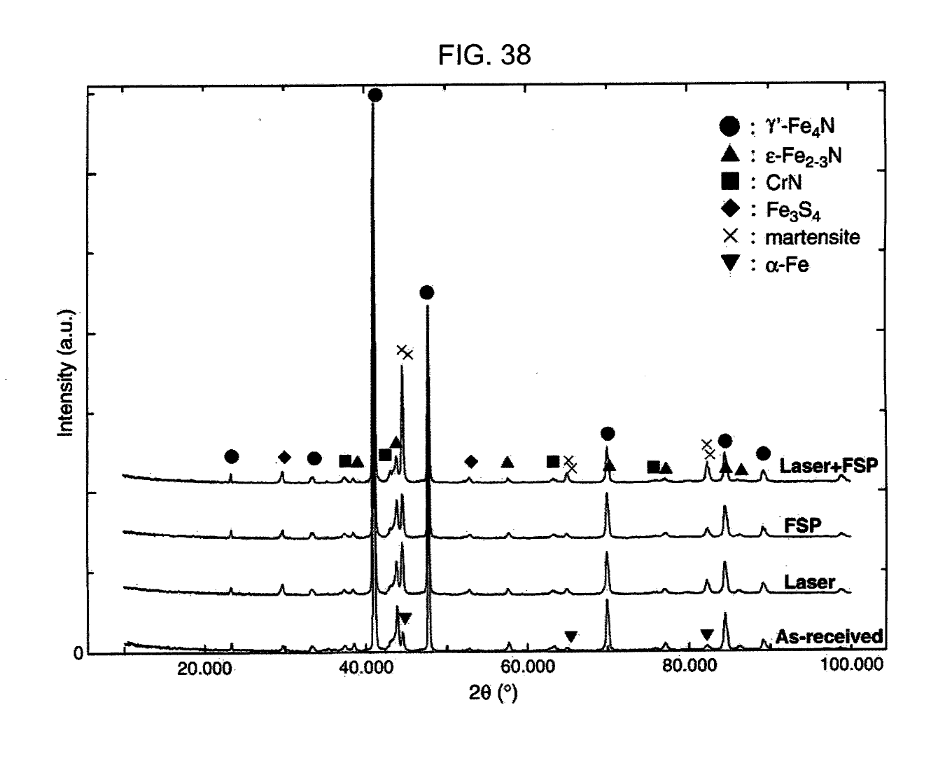

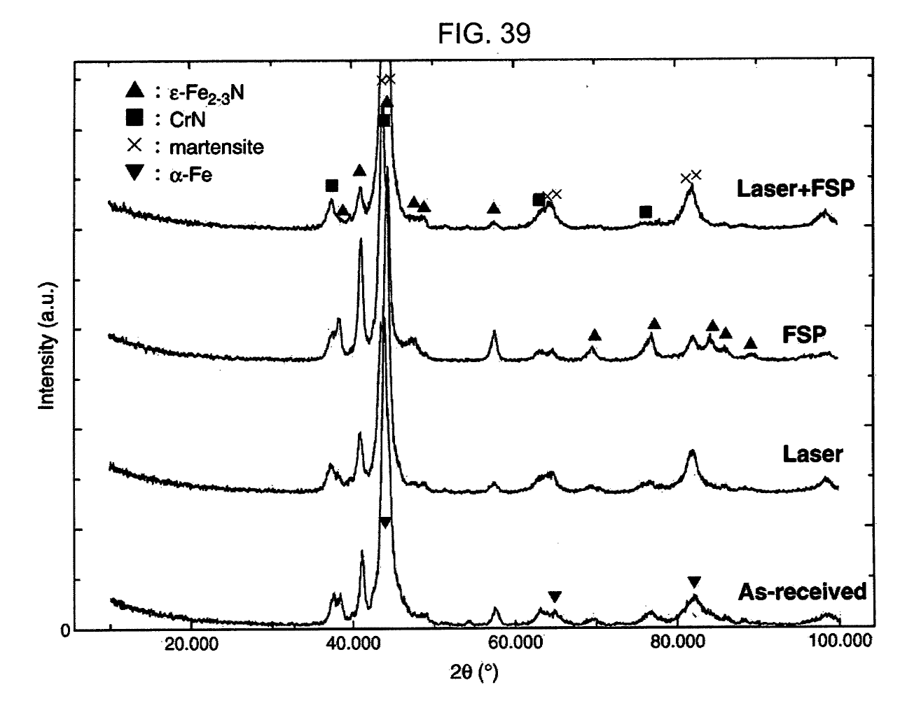

XRD patterns for the nitrided samples with and without the compound layer are shown in FIGS. 38 and 39, respectively. The compound layer was removed using #1500 emery paper after the first XRD measurement. The compound layer could be identified as γ′-Fe₄N because strong peaks attributed to γ′-Fe₄N in FIG. 38 had disappeared in FIG. 39. ε-Fe₂₋₃N and CrN were formed in the diffusion zone of all samples. It was confirmed that the crystal phase of the compound layer and the nitride particles formed in the diffusion zone were not affected by the microstructure before the nitriding.

FIG. 40 shows the microhardness depth profiles of the diffusion zone for the nitrided samples. The thickness of the diffusion zone varied by the microstructural modification of the SKD11 before the nitriding. The depth of the diffusion zone of the nitrided SKD11 without the pretreatment was about 50 μm and the microhardness was sharply decreased from the surface. Although the microhardness of the nitrided SKD11 after laser melting was higher than that of the other samples, it suddenly decreased to the same microhardness as the SKD11 without the nitriding at about 50 μm in depth. It is considered that the consumption of nitrogen by the reaction with the segregated fine chromium carbide particles led to the thin diffusion zone with a high microhardness. Compared with these two nitrided samples, the diffusion zone of the nitrided samples with FSP was thicker and reached about 80 μm. Additionally, the nitrided samples with FSP showed an ideal change in the microhardness which gradually decreased from the surface. The grain refinement by FSP enhanced the path for the diffusion of nitrogen to form the thick diffusion zone. Furthermore, there were no local formed nitride particles in the diffusion zone for the nitrided sample treated by the combination of laser melting and FSP. These results revealed that the combination of laser melting and FSP was an effective pretreatment for the SKD11 to form an excellent diffusion zone.

Compared with the results of The First, Second, Third, Fourth, Fifth and Sixth Examples, it is expected that blades made from the laser-treated and nitrided SKD11 will be sharper, stronger and more durable than blades made from the nitrided SKD11 without pretreatment. Furthermore, it is also expected that blades made from the FSPed and nitrided SKD11 and blades made from the laser-treated, FSPed and nitrided SKD11 will be sharper, stronger and more durable than the blades made from the laser-treated and nitrided SKD11.

### CONCLUSIONS

The microstructural control of the nitrided case on the SKD11 plate by laser melting and FSP was studied. The obtained results can be summarized as follows.

(1) The diffusion zone of uniform depth and microstructure without any local formation of the nitride particles can be obtained for the SKD11 by the combined pretreatment of laser melting and FSP.

(2) The crystal phase of the nitride is not influenced by the microstructural modification by laser melting and FSP. The compound layer is γ′-Fe₄N, and the nitride particles in the diffusion zone are ε-Fe₂₋₃N and CrN for all the nitrided samples.

(3) The microstructural modification of the SKD11 leads to differences in the thickness and the microhardness of the diffusion zone for the nitrided samples. The FSP before the nitriding increases the thickness and decreases the change in the microhardness from the surface.

What is claimed is:

1. A method of modifying a ferrous material comprising the steps of:
making carbide particles in a portion of a base material smaller; and
nitriding at least a part of said portion.

2. The method of claim 1 further comprising:
melting and solidifying a portion of the base material or applying a friction on a portion of the base material to make the carbide particles smaller.

3. The method of claim 1, further comprising:
exposing the base material in a gas containing a nitrogen atom to nitride at least the part of said portion.

4. The method of claim 3, further comprising:
exposing the base material in the gas containing the nitrogen atom at 300-800° C. for 3-8 hours.

5. The method of claim 1, further comprising:
nitriding at least the part of said portion within 72 hours after making the carbide particles smaller.

6. The method of claim 1, wherein the base material contains at least 1.2% of carbon, at least 10% of chromium or at most 1.5% of molybdenum.

7. A method of making a blade, comprising shaping the ferrous material modified by the method of claim 1 into the blade so that the nitrided part is located at an edge of the blade.

8. A ferrous material comprising:
a base material; and
a first area where an average size of carbide particles is smaller than that in the base material;
wherein said first area includes a nitrided portion.

9. The ferrous material of claim 8, wherein the average size of the carbide particles in said first area is less than one fifth of that in the base material.

10. The ferrous material of claim 8, wherein said nitrided portion is exposed to a surface of the ferrous material.

11. The ferrous material of claim 10, further comprising:
a second area including a nitrided portion, the second area being located outside of said first area;
wherein a depth of the nitrided portion in said first area from a surface of the ferrous material is deeper than a depth of the nitrided portion in said second area from a surface of the ferrous material.

12. The ferrous material of claim 11, wherein the depth of the nitrided portion in said first area from the surface of the ferrous material is more than 1.2 times deeper than the depth of the nitrided portion in said second area from the surface of the ferrous material.

13. The ferrous material of claim 8, wherein a nitride compound contained in said nitrided portion in a largest percentage is γ′-Fe₄N.

14. A blade made from the ferrous material of claim 10 comprising:
an edge including said nitrided portion.

15. A ferrous material, comprising:
an area where a micro-Vickers hardness with a load of 100 g at a depth of 60 μm from a surface of the ferrous material is more than one half of a micro-Vickers hardness with a load of 100 g at a depth of 20 μm from a surface of the ferrous material.

16. The ferrous material of claim 15, wherein the micro-Vickers hardness with the load of 100 g at the depth of 20 μm from the surface of the ferrous material in said area is more than 1000 Hv, and
wherein the micro-Vickers hardness with the load of 100 g at the depth of 60 μm from the surface of the ferrous material in said area is more than 500 Hv.

17. The ferrous material of claim 15, further comprising:
an area where a micro-Vickers hardness with a load of 100 g at a depth of 60 μm from a surface of the ferrous material is more than two thirds of a micro-Vickers hardness with a load of 100 g at a depth of 20 μm from a surface of the ferrous material, and where a micro-Vickers hardness with a load of 100 g at a depth of 100 μm from a surface of the ferrous material is more than one half of a micro-Vickers hardness with a load of 100 g at a depth of 20 μm from a surface of the ferrous material.

18. The ferrous material of claim 17, wherein the micro-Vickers hardness with the load of 100 g at the depth of 60 μm from the surface of the ferrous material in said area is more than 667 Hv, and
wherein the micro-Vickers hardness with the load of 100 g at the depth of 100 μm from the surface of the ferrous material in said area is more than 500 Hv.

19. The ferrous material of claim 17, wherein the micro-Vickers hardness with the load of 100 g at the depth of 60 μm from the surface of the ferrous material in said area is within ±20% of an average of the micro-Vickers hardness with the load of 100 g at the depth of 20 μm from the surface of the ferrous material in said area and the micro-Vickers hardness with the load of 100 g at the depth of 100 μm from the surface of the ferrous material in said area.

20. The ferrous material of claim 17, wherein the micro-Vickers hardness with the load of 100 g at the depth of 60 μm from the surface of the ferrous material is less than 90% of the micro-Vickers hardness with the load of 100 g at the depth of 20 μm from the surface of the ferrous material, and
wherein the micro-Vickers hardness with the load of 100 g at the depth of 100 μm from the surface of the ferrous material is less than 70% of the micro-Vickers hardness with the load of 100 g at the depth of 20 μm from the surface of the ferrous material.
